(19) United States
(12) Patent Application Publication
(10) Pub. No.: US 2025/0175240 A1
(43) Pub. Date: May 29, 2025

(54) SENSING BEAM MANAGEMENT

(71) Applicant: QUALCOMM INCORPORATED, San Diego, CA (US)

(72) Inventors: Yuwei REN, Beijing (CN); Weimin DUAN, San Diego, CA (US); Huilin XU, Temecula, CA (US)

(21) Appl. No.: 18/834,425

(22) PCT Filed: Apr. 5, 2022
(86) PCT No.: PCT/CN2022/085224

§ 371 Date: Jul. 30, 2024

(51) Int. Cl. H04B 7/08; H04W 24/10

(52) U.S. Cl. CPC H04B 7/088; H04W 24/10

(57) ABSTRACT

A method for CLI signal measurement includes: receiving, at an apparatus, a CLI configuration indicative of an uplink CLI signal corresponding to a transmitting user equipment; receiving, at the apparatus, the uplink CLI signal; measuring, at the apparatus, the uplink CLI signal to determine a Doppler measurement; and measuring, at the apparatus, the uplink CLI signal to determine a received power of the uplink CLI signal.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example apparatus includes: a receiver; a memory; and a processor, communicatively coupled to the receiver and the memory, configured to: receive, via the receiver, a cross-link interference (CLI) configuration indicative of an uplink CLI signal corresponding to a transmitting user equipment; receive, via the receiver, the uplink CLI signal; measure the uplink CLI signal to determine a Doppler measurement; and measure the uplink CLI signal to determine a received power of the uplink CLI signal.

An example method for CLI signal measurement includes: receiving, at an apparatus, a CLI configuration indicative of an uplink CLI signal corresponding to a transmitting user equipment; receiving, at the apparatus, the uplink CLI signal; measuring, at the apparatus, the uplink CLI signal to determine a Doppler measurement; and measuring, at the apparatus, the uplink CLI signal to determine a received power of the uplink CLI signal.

Another example apparatus includes: means for receiving a CLI configuration indicative of an uplink CLI signal corresponding to a transmitting user equipment; means for receiving the uplink CLI signal; means for measuring the uplink CLI signal to determine a Doppler measurement: and means for measuring the uplink CLI signal to determine a received power of the uplink CLI signal.

An example non-transitory, processor-readable storage medium includes processor-readable instructions configured to cause a processor of an apparatus to: receive a CLI configuration indicative of an uplink CLI signal corresponding to a transmitting user equipment; receive the uplink CLI signal; measure the uplink CLI signal to determine a Doppler measurement; and measure the uplink CLI signal to determine a received power of the uplink CLI signal.

Another example apparatus includes: a transceiver; a memory: and a processor, communicatively coupled to the transceiver and the memory, configured to: obtain a transmit beam schedule indicating a sequence of a plurality of transmit beams of a transmitting user equipment for transmitting an uplink CLI signal; obtain one or more measurements of the uplink CLI signal made by a receiving device, each of the one or more measurements corresponding to a respective one of the plurality of transmit beams; determine, based on the one or more measurements, a best transmit beam of the plurality of transmit beams for transmitting the uplink CLI signal; and cause the transmitting user equipment to transmit a radio frequency sensing signal using the best transmit beam.

An example method for beam management includes: obtaining, at an apparatus, a transmit beam schedule indicating a sequence of a plurality of transmit beams of a transmitting user equipment for transmitting an uplink CLI signal; obtaining, at the apparatus, one or more measurements of the uplink CLI signal made by a receiving device, each of the one or more measurements corresponding to a respective one of the plurality of transmit beams; and determining, at the apparatus and based on the one or more measurements, a best transmit beam of the plurality of transmit beams for transmitting the uplink CLI signal.

Another example apparatus includes: means for obtaining a transmit beam schedule indicating a sequence of a plurality of transmit beams of a transmitting user equipment for transmitting an uplink CLI signal; means for obtaining one or more measurements of the uplink CLI signal made by a receiving device, each of the one or more measurements corresponding to a respective one of the plurality of transmit beams; and means for determining, based on the one or more measurements, a best transmit beam of the plurality of transmit beams for transmitting the uplink CLI signal.

Another example non-transitory, processor-readable storage medium includes processor-readable instructions configured to cause a processor of an apparatus to: obtain a transmit beam schedule indicating a sequence of a plurality of transmit beams of a transmitting user equipment for transmitting an uplink CLI signal; obtain one or more measurements of the uplink CLI signal made by a receiving device, each of the one or more measurements corresponding to a respective one of the plurality of transmit beams; and determine, based on the one or more measurements, a best transmit beam of the plurality of transmit beams for transmitting the uplink CLI signal.

An example network entity includes: a transceiver; a memory; and a processor, communicatively coupled to the transceiver and the memory, configured to: transmit, via the transceiver, to a transmitting user equipment, one or more transmission schedules, for transmission of a plurality of uplink CLI signal occasions, configured to cause the transmitting user equipment to transmit the plurality of uplink CLI signal occasions: and transmit, via the transceiver, to a receiving user equipment, one or more reception schedules, for receiving the plurality of uplink CLI signal occasions, configured to cause the receiving user equipment to receive the plurality of uplink CLI signal occasions; where: the one or more transmission schedules are configured to cause the transmitting user equipment to transmit the plurality of uplink CLI signal occasions using multiple transmit beams of the transmitting user equipment; or the one or more reception schedules are configured to cause the receiving user equipment to receive the plurality of uplink CLI signal occasions using multiple receive beams of the receiving user equipment; or a combination thereof.

An example method for sensing signal scheduling includes: transmitting, from a network entity to a transmitting user equipment, one or more transmission schedules, for transmission of a plurality of uplink CLI signal occasions, configured to cause the transmitting user equipment to transmit the plurality of uplink CLI signal occasions; and transmitting, from the network entity to a receiving user equipment, one or more reception schedules, for receiving the plurality of uplink CLI signal occasions, configured to cause the receiving user equipment to receive the plurality of uplink CLI signal occasions; where: the one or more transmission schedules are configured to cause the transmitting user equipment to transmit the plurality of uplink CLI signal occasions using multiple transmit beams of the transmitting user equipment; or the one or more reception schedules are configured to cause the receiving user equipment to receive the plurality of uplink CLI signal occasions using multiple receive beams of the receiving user equipment; or a combination thereof.

Another example network entity includes: means for transmitting, to a transmitting user equipment, one or more transmission schedules, for transmission of a plurality of uplink CLI signal occasions, configured to cause the transmitting user equipment to transmit the plurality of uplink CLI signal occasions; and means for transmitting, entity to a receiving user equipment, one or more reception schedules, for receiving the plurality of uplink CLI signal occasions, configured to cause the receiving user equipment to receive the plurality of uplink CLI signal occasion; where: the one or more transmission schedules are configured to cause the transmitting user equipment to transmit the plurality of uplink CLI signal occasions using multiple transmit beams of the transmitting user equipment; or the one or more reception schedules are configured to cause the receiving user equipment to receive the plurality of uplink CLI signal occasions using multiple receive beams of the receiving user equipment; or a combination thereof.

Another example non-transitory, processor-readable storage medium includes processor-readable instructions configured to cause a processor of a network entity to: transmit, to a transmitting user equipment, one or more transmission schedules, for transmission of a plurality of uplink CLI signal occasions, configured to cause the transmitting user equipment to transmit the plurality of uplink CLI signal occasions; and transmit, entity to a receiving user equipment, one or more reception schedules, for receiving the plurality of uplink CLI signal occasions, configured to cause the receiving user equipment to receive the plurality of uplink CLI signal occasions; where: the one or more transmission schedules are configured to cause the transmitting user equipment to transmit the plurality of uplink CLI signal occasions using multiple transmit beams of the transmitting user equipment; or the one or more reception schedules are configured to cause the receiving user equipment to receive the plurality of uplink CLI signal occasions using multiple receive beams of the receiving user equipment; or a combination thereof.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a simplified block diagram of an example user equipment.

FIG. 6 is a simplified block diagram of an example network entity.

FIG. 7 is a timing diagram showing possible cross-link interference.

FIG. 8 is an example environment for cross-link interference and radio frequency sensing.

FIG. 9 illustrates different transmit beams and receive beams being used for sensing and communication.

FIG. 10 is a simplified example processing and signal flow for radio frequency sensing leveraging beam management based on cross-link interference.

FIG. 11 is a simplified example processing and signal flow for selecting a receive beam as shown in FIG. 10.

FIG. 12 illustrates using multiple receive beams to measure signals from one transmit beam for selecting a receive beam.

FIG. 13 is a simplified example processing and signal flow for selecting a transmit beam as shown in FIG. 10.

FIG. 14 illustrates using multiple transmit beams to transmit signals received by one receive beam for selecting a transmit beam.

FIG. 15 is a simplified example processing and signal flow for multi-directional sensing.

FIG. 16A illustrates using multiple receive beams to measure signals from one transmit beam as part of multi-directional sensing.

FIG. 16B illustrates using multiple receive beams to measure signals from another transmit beam as part of multi-directional sensing.

FIG. 16C illustrates using multiple receive beams to measure signals from another transmit beam as part of multi-directional sensing.

FIG. 17 illustrates using each of multiple transmit beams to transmit multiple signal occasions for multi-directional sensing.

FIG. 18 illustrates using each of multiple transmit beams in each of multiple signal occasions to transmit signals in respective resources for multi-directional sensing.

FIG. 19 is a block flow diagram of a method for cross-link interference signal measurement.

FIG. 20 is a block flow diagram of a method for beam management.

FIG. 21 is a block flow diagram of a method of sensing signal scheduling.

### DETAILED DESCRIPTION

Techniques are discussed herein for joint radio frequency sensing and communication. A cross-link interference (CLI) procedure (where an uplink (UL) signal is transmitted (that may induce CLI if transmitted concurrently with a downlink (DL) signal in the same resource) and measured) may be leveraged for sensing beam management, to determine one or more beams to use for radio frequency (RF) sensing to determine target object characteristics (e.g., presence, location, speed, direction, etc.). For example, a sensing metric may be determined from a CLI signal (a UL signal that shares a resource with a DL signal and thus that induces CLI or that would induce CLI if transmitted concurrently with the DL signal). The sensing metric may include a Doppler value and a received power such as a reference signal received power value. As another example, a receiver of a CLI signal may have multiple receive beams and a particular receive beam (e.g., an optimum receive beam) may be determined from receiving the CLI signal, with the particular receive beam to be used for receiving future RF sensing signals. The particular receive beam may be determined based on Doppler values of the CLI signal received by the multiple receive beams and/or based on received power of the CLI signal received by the multiple receive beams (e.g., based on received power of the CLI signal for receive beams that received the CLI signal with non-zero Doppler values). As another example, a transmitter of a CLI signal may have multiple transmit beams and a particular transmit beam (e.g., an optimum transmit beam) may be determined from transmitting the CLI signal to a receiver (having been reflected by a target object), with the particular transmit beam to be used to transmit future RF sensing signals. The particular transmit beam may be determined based on Doppler values of the CLI signal received by the receiver and/or based on received power of the CLI signal received by the receiver (e.g., based on received power of the CLI signal for transmit beams where the CLI signal was received with non-zero Doppler values). As another example, multiple receive beams of a receiver may be used (e.g., intermittently) to receive RF sensing signals and/or multiple transmit beams of a transmitter may be used (e.g., intermittently) to transmit RF sensing signals to provide RF sensing coverage in multiple directions. Other examples, however, may be implemented.

Items and/or techniques described herein may provide one or more of the following capabilities, as well as other capabilities not mentioned. Speed estimates of target objects may be determined from sensing. Compared to prior RF sensing techniques, more accurate sensing information may be determined, such as a more accurate target object location estimate and/or a more accurate target object speed estimate. Broader coverage of RF sensing may be provided compared to prior RF sensing techniques. A legacy CLI procedure may be leveraged to perform beam management to select a transmit beam and/or a receive beam for RF sensing. By selecting a particular transmit beam and/or a particular receive beam for RF sensing based on the CLI procedure, RF sensing accuracy may be improved and/or RF sensing latency reduced. Radio frequency sensing beam management may be performed without dedicated sensing resource cost. As there is no specific connection for a user equipment with CLI, any adjacent user equipment may be helpful for the beam management and for use in RF sensing, which may increase sensing coverage. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT). unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on JEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

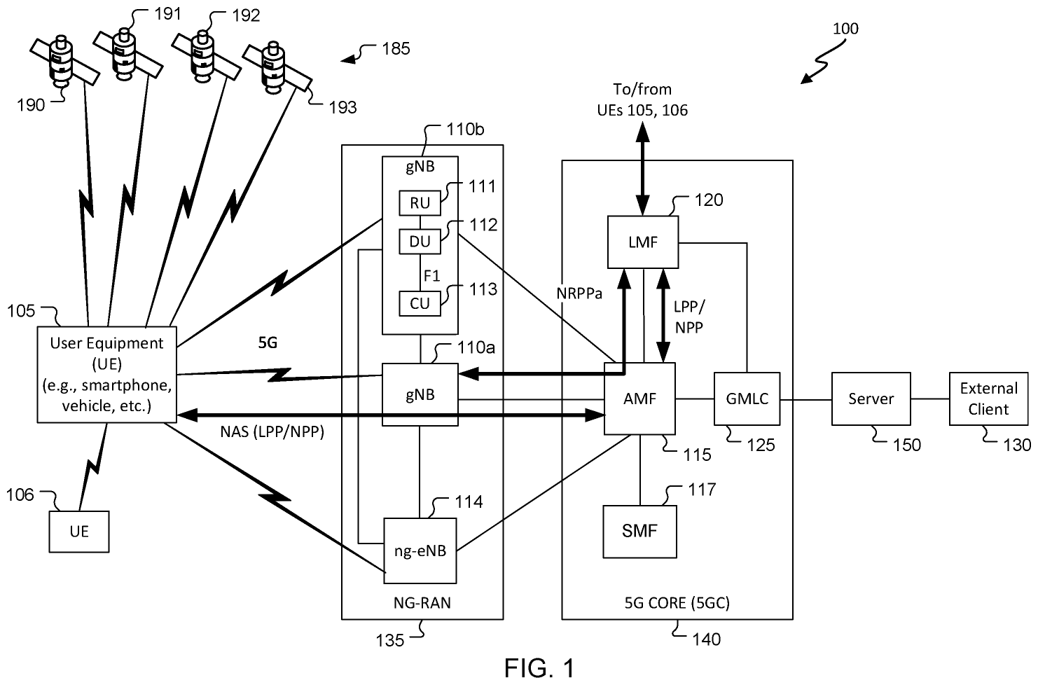

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi. WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS (Synchronization Signals) or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD). Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

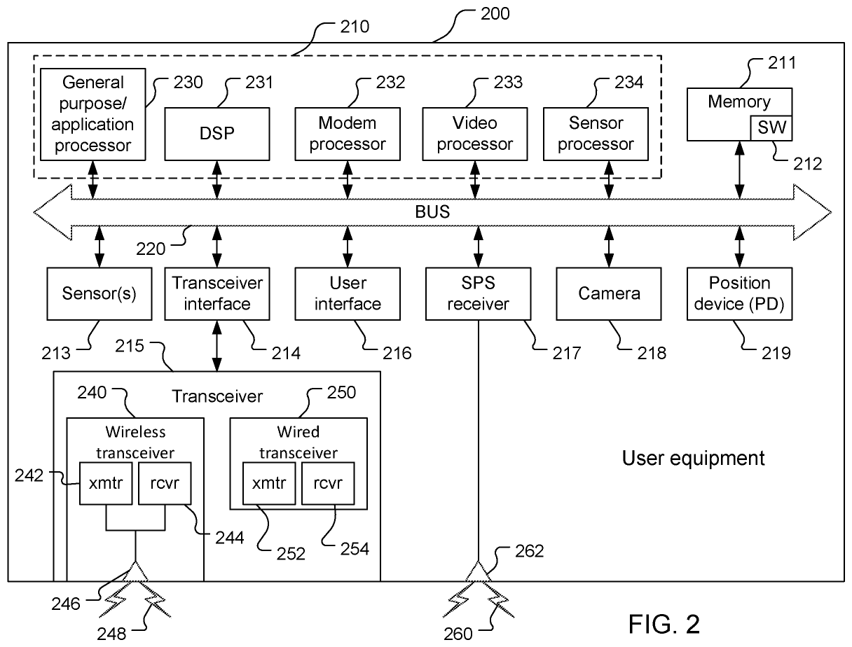

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

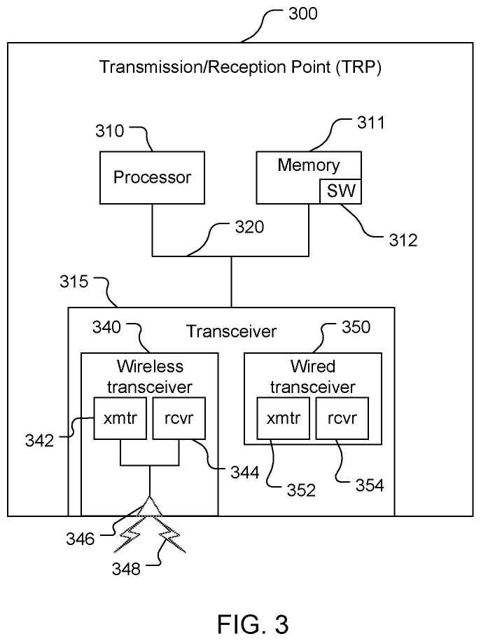

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

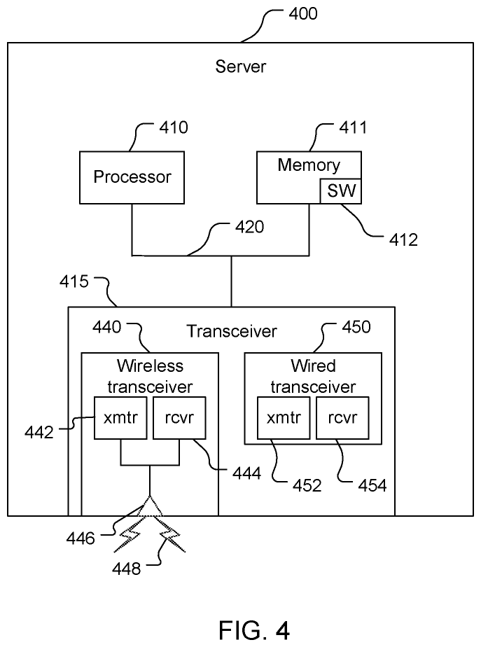

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AOD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-laver parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods. UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

### Sensing Leveraging Cross-Link Interference Procedure

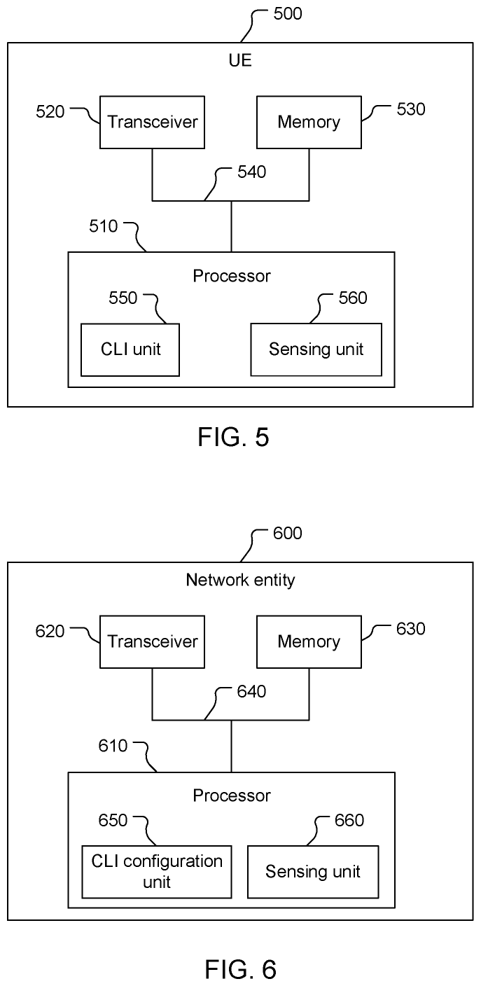

Referring also to FIG. 5, a UE 500 includes a processor 510, a transceiver 520, and a memory 530 communicatively coupled to each other by a bus 540. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) includes a CLI unit 550 (Cross-Link Interference unit) and a sensing unit 560. The CLI unit 550 and the sensing unit 560 are discussed further below, and the description may refer to the processor 510 generally, or the UE 500 generally, as performing any of the functions of the CLI unit 550 or the sensing unit 560. The UE 500 is configured to perform the functions of the CLI unit 550 and the sensing unit 560 discussed herein.

Referring also to FIG. 6, a network entity 600 includes a processor 610, a transceiver 620, and a memory 630 communicatively coupled to each other by a bus 640. The network entity 600 may include the components shown in FIG. 6. The network entity 600 may include one or more other components such as any of those shown in FIG. 3 and/or FIG. 4 such that the TRP 300 and/or the server 400 may be an example of the network entity 600. For example, the processor 610 may include one or more of the components of the processor 310 and/or the processor 410. The transceiver 620 may include one or more of the components of the transceiver 315 and/or the transceiver 415. The memory 630 may be configured similarly to the memory 311 and/or the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) includes a CLI configuration unit 650 and a sensing unit 660. The CLI configuration unit 650 and the sensing unit 660 are discussed further below, and the description may refer to the processor 610 generally, or the network entity 600 generally, as performing any of the functions of the CLI configuration unit 650 or the sensing unit 660. The network entity 600 is configured to perform the functions of the CLI configuration unit 650 and the sensing unit 660 discussed herein.

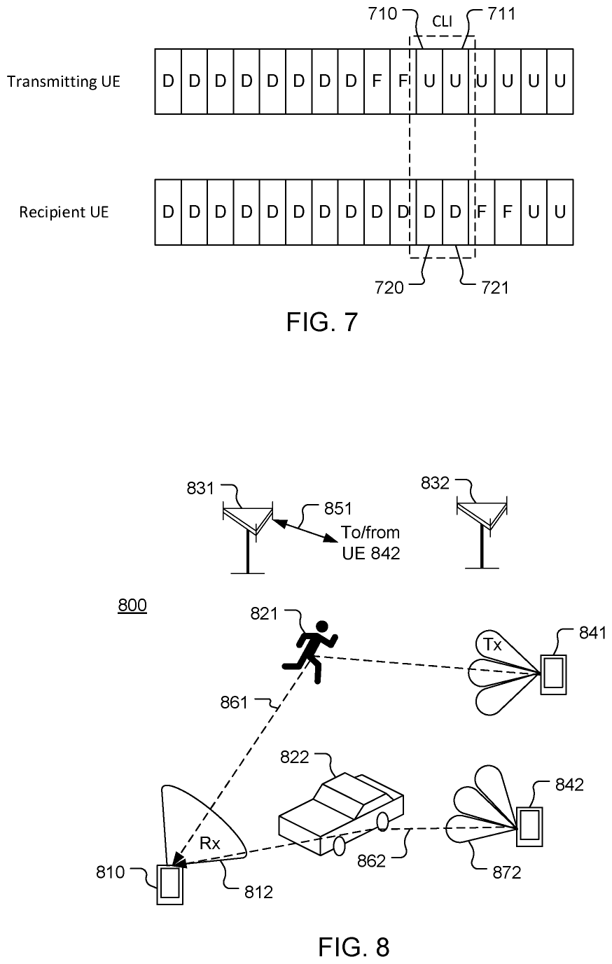

Cross-link interference (CLI) is an interference issue between a transmitting UE (transmitting a UL signal) and a receiving UE (receiving a DL signal). In a time-domain-duplex (TDD) system, nearby UEs have different UL-DL (uplink-downlink) slot formats. When a receiving UE (also called a victim UE) receives a transmission from the transmitting UE (also called an aggressor UE) within a UL symbol (i.e., an interfering symbol) of the transmitting UE that collides with a DL symbol of the receiving UE, this is known as CLI. For example, referring also to FIG. 7, uplink transmissions (U) in symbols 710, 711 from a transmitting UE overlap with, and may interfere with, reception of downlink signals (D) in symbols 720, 721 by a receiving UE from a TRP. The symbols 710, 711 may thus be considered CLI signals or parts of a single CLI signal. The CLI is caused the by the UL transmission from the transmitting UE, such as a PUCCH (Physical Uplink Control Channel), PUSCH (Physical Uplink Shared Channel), PRACH (Physical Random Access Channel), or SRS (Sounding Reference Signal) transmission. The network entity 600, e.g., a server (e.g., an LMF) and/or a base station (e.g., a gNB), may configure CLI resources (e.g., a reference signal that induces CLI) for interference management. For example, the reference signal (RS) may configured for transmission by the aggressor UE. The receiving UE may be configured to measure the reference signal in the resource causing the CLI without the transmitting UE being affected, e.g., without affecting the UL transmission that causes the CLI. For example, a measurement may be an SRS-RSRP, i.e., the received power of an SRS, or a CLI-RSSI, i.e., the strength of the signal causing the CLI. SRS-RSRP may include a linear average of the power contributions of the SRS to be measured over configured resource elements within a considered measurement frequency bandwidth in the time resources in the configured measurement occasions. CLI-RSSI may include a linear average of a total received power observed in certain OFDM symbols of measurement time resource(s), in the measurement bandwidth, over the configured resource elements for measurement by the receiving UE. The terms “receiving UE” and “transmitting UE” refer to the signaling regarding CLI and are not limiting of the UEs, e.g., the receiving UE may transmit signals and the transmitting UE may receive signals (e.g., the receiving UE may act as a transmitting UE (e.g., at another time) for CLI and/or the transmitting UE may act as a receiving UE (e.g., at another time) for CLI).

Referring also to FIG. 8, measurements of CLI signals or non-CLI reference signals may be used for sensing to monitor an environment 800 in which a receiving UE 810 (which is an example of the UE 500) is disposed, to track motion of one or more target objects 821, 822, and/or to determine a position of the receiving UE 810. The receiving UE 810 connects to an attached node 831 (e.g., a base station), without dedicated synchronization or connection with other UEs (e.g., transmitting UEs 841, 842) or nodes (e.g., a node 832). For sensing, the receiving UE 810 may perform the sensing based on any adjacent transmitting UE that transmits a sensing signal (that may be a CLI signal or another signal (e.g., that may not produce CLI)). The sensing may cover any direction from which signals are received, not being constrained by a connection with another UE by sidelink (SL). Also, measurement of a CLI signal is not constrained by a connection with another UE by SL. With sidelink, a link is built between UEs and there is a dedicated resource for communication while in sensing or a CLI procedure (where one or more CLI signals are transmitted and measured, e.g., transmitted by the UE 842 directly to the UE 810 that measures the CLI signal), the receiving UE 810 need not build a connection with the transmitting UEs 841, 842. CLI signal measurement and sensing are transparent to the transmitting UEs 841, 842 and do not occupy the dedicated resource. CLI SRS is based on a Uu connection, e.g., a Uu connection 851 between the receiving UE 842 and the attached node 831. Sensing may cover more directions/areas based on the distribution of the transmitting UEs 841, 842 and/or other transmitting UEs. Different transmitting UEs send sensing signals from different directions. Transmitting UEs may be disposed in the same cell as the receiving UE 810 (for intra-cell sensing) and/or in a different cell from the receiving UE 810 (for inter-cell sensing). The transmitting UEs 841, 842 are configured with respective SRS resources and are adjacent to the receiving UE 810, i.e., close enough to the receiving UE 810 for signals 861, 862 to be measured by the receiving UE 810. The receiving UE 810 is configured (e.g., through assistance data provided to the receiving UE 810) to measure the CLI SRS resources of the transmitting UEs 841, 842. The receiving UE 810 (e.g., the sensing unit 560) can measure the signals 861, 862 and extract a sensing feature which may be used to determine presence of the target objects 821, 822, and location and/or motion of the target objects 821, 822.

In Release 16 of the 3GPP standard regarding CLI, the impact of uplink (UL) transmission on downlink (DL) reception by a receiving UE is measured without concern for beam configuration. For example, the transmitting UE 842 transmits the signal 862 using a default transmit beam 872 (Tx) for UL transmission and the receiving UE 810 receives the signal 862 using a DL reception beam 812. Such beam setting is uncomplicated and without signaling cost, but does not allow for estimating the interference level with different beam configurations in various directions.

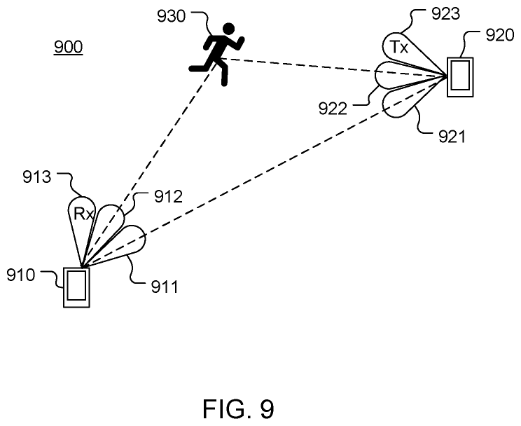

Referring also to FIG. 9, different transmit (Tx) beams and/or receive (Rx) beams may be desired for sensing versus for communication. For example, in communication a high throughput is desired and the beams of a transmitting UE 920 and a receiving UE 910 should be aligned. A general rule is to select a beam pair with a highest RSRP, which is typically the beam pair that has line-of-sight (LOS) propagation, here a transmit beam 921 of the transmitting UE 920 and a receive beam 911 of the receiving UE 910. A goal of sensing is to monitor an environment 900, e.g., motion of a target object 930 (e.g., walking, breathing corresponding to micro Doppler information, etc.). To accomplish this goal, the selected Tx and Rx beams will point toward the target object 930, here a transmit beam 922 of the transmitting UE 920 and a receive beam 912 of the receiving UE 910, with a received signal quality being good enough (e.g., an RSRP being high enough) for the receiving UE 910 to measure a sensing feature with sufficient accuracy. While a Tx UE and an Rx UE are discussed, other devices, e.g., a base station, may be used instead of either or both of these devices.

To help improve accuracy of sensing, e.g., to determine a position of a target object accurately in an environment (e.g., a room), techniques are discussed herein for determining beam configurations based on a present situation, e.g., to cover multiple directions. For example, beams may be swept or selected and one or more best beam configurations selected for use in sensing whereas legacy CLI procedures have not considered beam impact, focusing on interference management based on a default beam setting. Techniques discussed herein consider beam configurations to provide sensing beam enhancement (e.g., beam selection) to improve performance of sensing, e.g., improve accuracy of target object location estimation and/or target object motion estimation. Sensing configurations may be primarily directed toward receiving UEs. Techniques discussed herein include determining a sensing metric for beam measurement, selecting a desired (e.g., optimal) Rx beam from multiple possible Rx beams for sensing, selecting a desired (e.g., optimal) Tx beam from multiple possible Tx beams for sensing, and beam sweeping (e.g., intermittently) for sensing in multiple directions using a CLI procedure. Sensing techniques discussed herein may leverage legacy CLI signaling, which avoids incurring cost for using a dedicated sensing signal, and allows (any) adjacent transmitting device to help with sensing, which helps provide a large sensing coverage area. An adjacent transmitting device is a device whose transmitted signal may be reflected and then received and measured by a receiving device with sufficient accuracy.

Sensing and/or use of a CLI procedure (e.g., to select an Rx beam and/or a Tx beam) may be transparent to the transmitting device, with the transmitting device being unaware of signals transmitted by the transmitting device being used for sensing or beam selection. Consequently, an optimum transmit beam and/or an optimum receive beam may be used for sensing. A desired transmit beam and/or a desired receive beam may be selected from possible transmit beams and/or possible receive beams, respectively. While for communication, the transmit and receive beams are selected in concert, sensing beam enhancement may be considered two independent procedures to select a desired transmit beam and to select a desired receive beam. Depending on a present scenario (e.g., a present environment such as a location of a target object relative to the transmitting device and/or the receiving device), a receive beam and/or a transmit be may be selected (e.g., to point toward the target object). For example, a receive beam (e.g., an optimum receive beam) may be selected while a default transmit beam is used. As another example, a transmit beam (e.g., an optimum transmit beam) may be selected while a default receive beam is used. As another example, both a receive beam and a transmit beam may be selected from multiple possible receive beams and transmit beams. As another example, multiple receive beams and multiple transmit beams may be used, e.g., swept, for transmitting/receiving CLI signals such that multiple (e.g., all) possible combinations of transmit beams of a transmitting UE and receive beams of a receiving UE are used for sensing using CLI signals to provide multi-directional sensing using CLI signals.

The network entity 600 may be configured to request, and the UE 500 is configured to measure, an indication of received power of an uplink CLI signal and Doppler information of the uplink CLI signal. For example, the CLI configuration unit 650 of the network entity 600 may send an explicit request for the UE 500 to measure received power and Doppler shift of a received uplink CLI signal. As another example, scheduling of receipt of an uplink CLI signal by the UE 500 may be an implicit request for the UE 500 to measure power and Doppler of the uplink CLI signal. The CLI unit 550 of the UE 500 may be configured to measure an RSRP of the uplink CLI signal and to measure Doppler information (e.g., Doppler shift, speed). The CLI unit 550 may leverage different filters to measure the RSRP compared to measuring the legacy SRS-RSRP of Release 16 of the 3GPP (3^{rd} Generation Partnership Project) technical specification. The Doppler information (value(s)) represents mobility status of a target object and may be referred to as speed information (value(s)), which may be provided in any of a variety of units (e.g., m/s, km/hour, etc.). For example, a Doppler value (which may be referred to as a Doppler) of zero (0) may indicate that the target object is static, or that the uplink CLI signal did not reflect off a target object. As another example, a non-zero Doppler value (e.g., 1 m/s) indicates that a target object is present and moving. The CLI unit 550 may be configured to determine other information such as a range from the UE 500 to a target object. The CLI unit 550 may be configured to determine the range to the target object from the RSRP and/or from latency information (i.e., round-trip time). The measurements and/or information derived from the measurements (e.g., range) may be reported in a beam measurement report.

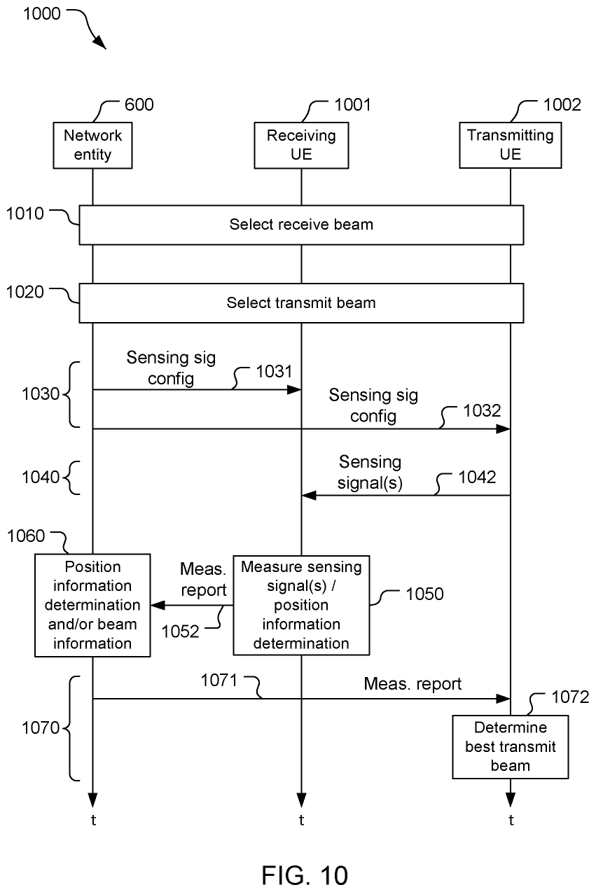

Referring also to FIG. 10, a processing and signal flow 1000 for beam selection and sensing includes the stages shown. The flow 1000 is an example, and stages may be added to, removed from, and/or rearranged in, the flow 1000. For example, stage 1010 may be omitted and/or stage 1020 may be omitted. Various implementations of stage 1030 may be used, some of which are discussed below. At stage 1010, a receive beam of a receiving UE 1001 (that is an example of the UE 500, with the CLI unit 550 configured for processing received uplink CLI signals) may be selected from multiple possible receive beams of the receiving UE 1001. At stage 1020, a transmit beam of a transmitting UE 1002 may be selected from multiple possible transmit beams of the transmitting UE 1002. The transmitting UE 1002 may be an example of the UE 500 with or without the CLI unit 550 configured for processing received uplink CLI signals, and/or with the CLI unit 550 configured for selecting a transmit beam, e.g., as discussed with respect to stage 1072. At stage 1030, the network entity 600 provides sensing signal configuration information regarding one or more RF sensing signals (e.g., uplink SRS) to be transmitted by the transmitting UE 1002. At stage 1040, the transmitting UE 1002 transmits one or more sensing signals 1042 to the receiving UE 1001 (e.g., via one or more target objects). At stage 1050, the receiving UE 1001 measures the one or more sensing signals 1042 to determine position information (e.g., one or more signal measurements, and possibly information derived from the signal measurement(s) such as one or more ranges, one or more target object locations, etc.). At stage 1060, the network entity 600 may determine position information (e.g., one or more ranges, one or more target object locations, etc.) based on position information provided by the receiving UE 1001. At stage 1070, the transmitting UE 1002 may determine a transmit beam for use in transmitting signals such as sensing signals.

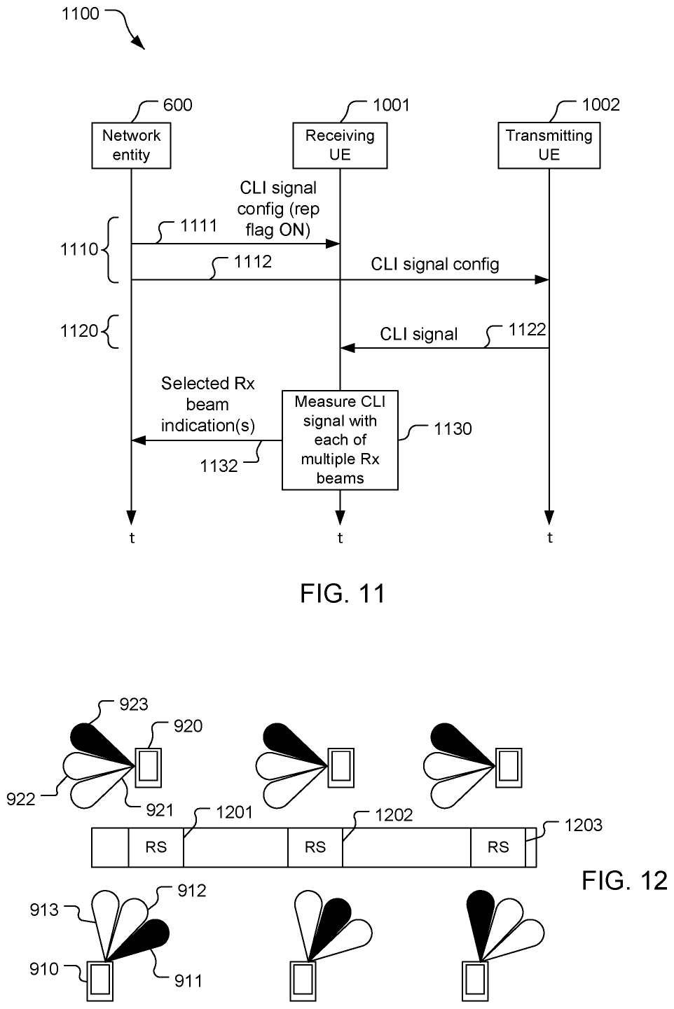

Referring also to FIG. 11, as an example of stage 1010, a processing and signal flow 1100 for selecting a receive beam of the receiving UE 1001 includes the stages shown. The flow 1100 is an example, and stages may be added to, removed from, and/or rearranged in, the flow 1100.

At stage 1110, the network entity 600, e.g., the CLI configuration unit 650, transmits a CLI signal configuration 1111 to the receiving UE 1001 and a CLI signal configuration 1112 to the transmitting UE 1002. The CLI signal configuration 1111 indicates the configuration of an uplink CLI signal to be measured by the receiving UE 1001, e.g., SRS resources of multiple occasions of the uplink CLI signal to be measured by the CLI unit 550. The CLI signal configuration 1111 includes a repetition flag set to an “ON” value indicating that the same transmit beam will be used by the transmitting UE 1002 to transmit the multiple occasions of the CLI signal. The ON value indicates to the receiving UE 1001 to measure the multiple occasions of the CLI signal using different receive beams of the transceiver 520. The CLI signal configuration 1112 indicates the configuration of an uplink reference signal (RS) to be transmitted by the transmitting UE 1002. The uplink RS will be the uplink CLI signal, but the transmitting UE 1002 may be unaware that the uplink RS will be an uplink CLI signal, the nature of the CLI signal being transparent to the transmitting UE 1002.

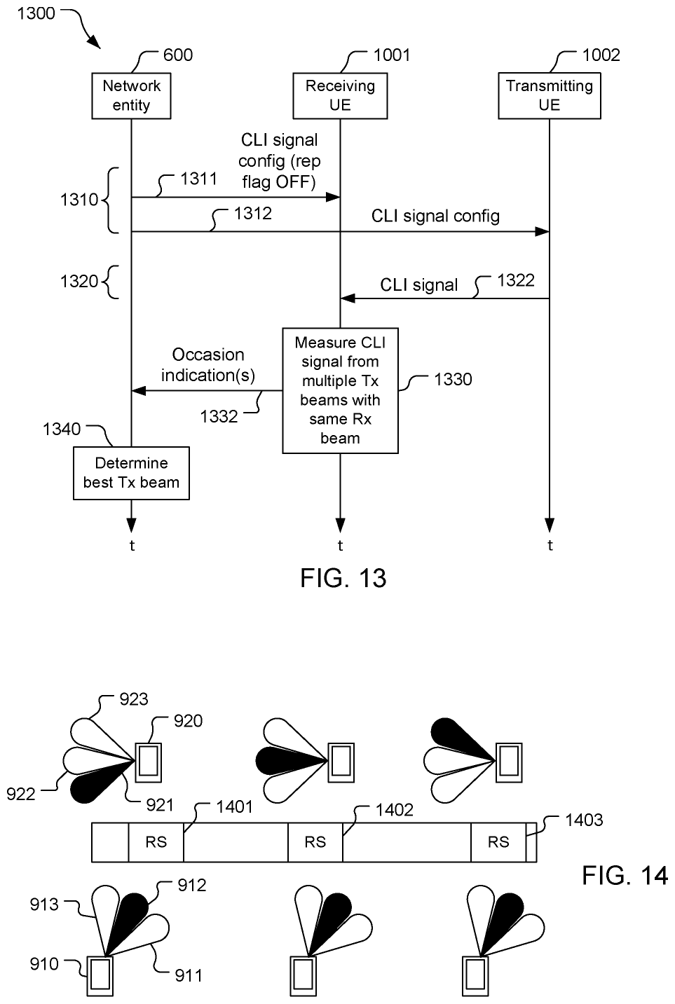

At stage 1120, the transmitting UE 1002 transmits a CLI signal 1122 to the receiving UE 1001. The transmitting UE 1002 transmits the CLI signal 1122 in multiple occasions using the same transmit beam in accordance with the CLI signal configuration 1112. For example, the transmitting UE 920 may transmit the CLI signal 1122 with the transmit beam 921, or the transmit beam 922, or a transmit beam 923. The transmitting UE 920 may, for example, transmit the CLI signal 1122 using a default beam, e.g., a Uu UL beam aligned with legacy CLI. As another example, the transmitting UE 1002 may transmit the CLI signal 1122 with a beam indicated by the CLI signal configuration 1112, or with a beam determined by the transmitting UE 1002. The indicated or determined beam may be different than the UL transmission beam, e.g., may be a wide beam to provide a large coverage area. As another example, the indicated or determined beam may be an optimum beam, e.g., determined as discussed below with respect to FIG. 13, or based on historical information (e.g., a beam that was used to track a target object successfully) and/or position information (e.g., locations of the transmitting UE 1002 and a target object). Referring also to FIG. 12, in an example, the transmitting UE 920 uses the transmit beam 923 to transmit an occasion 1201, an occasion 1202, and an occasion 1203 of the RS that is the CLI signal 1122.

At stage 1130, the receiving UE 1001 measures the CLI signal using each of multiple receive beams of the transceiver 520. For example, the CLI unit 550 measures different occasions of the CLI signal 1122 using different respective receive beams. For example, the receiving UE 910 may receive the CLI signal 1122 with each of the receive beam 911, the receive beam 912, and a receive beam 913, e.g., sweeping the receive beams 911-913 for the occasions of the CLI signal 1122. In the example shown in FIG. 12, the receiving UE 910 receives the occasion 1201 using the receive beam 911, the occasion 1202 using the receive beam 912, and the occasion 1203 using the receive beam 913. The CLI unit 550 may determine one or more measurements, e.g., RSRP. RSSI, and/or Doppler, for the CLI signal 1122 as received by each of the receive beams 911-913. The CLI unit 550 may determine, based on the measurement(s) and the repetition flag being set to ON, to transmit, via the transceiver 520, one or more selected Rx beam indications 1132. For example, the selected Rx beam indication(s) 1132 may report the receive beam, of the multiple receive beams used to receive the CLI signal 1122, corresponding to a largest measured RSRP, a largest measured RSSI, from multiple RSRP measurements corresponding to the multiple receive beams. As another example, the selected Rx beam indication(s) 1132 may report the receive beam corresponding to a largest Doppler value. As another example, the selected Rx beam indication(s) 1132 may report the receive beam corresponding to a largest measured RSRP, or largest measured RSSI, from among the receive beams with non-zero Doppler value measurements. As another example, the selected Rx beam indication(s) 1132 may report all receive beams with one or more corresponding measurement values (e.g., RSRP, RSSI, and/or Doppler) that exceed one or more corresponding threshold values (e.g., an RSRP threshold, an RSSI threshold, and/or a Doppler threshold). The Rx beam indication(s) 1132 may include, for example, a beam index for each reported receive beam and the measured value(s) for each reported receive beam. The Rx beam indication(s) may indicate a selected beam, or may be used to select a beam, for receiving sensing signals. By selecting a particular receive beam, based on measured CLI signal(s) for receiving sensing signals, measurement accuracy may be improved, which may improve sensing such as position estimate accuracy of a target object and/or speed estimate accuracy for the target object, etc.

Referring also to FIG. 13, as an example of stage 1020, a processing and signal flow 1300 for selecting a transmit beam of the transmitting UE 1002 includes the stages shown. The flow 1300 is an example, and stages may be added to, removed from, and/or rearranged in, the flow 1300.

At stage 1310, the network entity 600, e.g., the CLI configuration unit 650, transmits a CLI signal configuration 1311 to the receiving UE 1001 and a CLI signal configuration 1312 to the transmitting UE 1002. The CLI signal configuration 1311 indicates the configuration of an uplink CLI signal to be measured by the receiving UE 1001, e.g., SRS resources of multiple occasions of the uplink CLI signal to be measured by the CLI unit 550. The CLI signal configuration 1311 includes the repetition flag set to an “OFF”' value indicating that the transmitting UE 1002 will be using multiple transmit beams to transmit the multiple occasions of the CLI signal. The OFF value indicates to the receiving UE 1001 to measure the multiple occasions of the CLI signal using the same receive beam of the transceiver 520. The CLI signal configuration 1311 may indicate a receive beam for the receiving UE 1001 to use to measure multiple occasions of the CLI signal. The CLI signal configuration 1312 indicates the configuration of an uplink reference signal (RS) to be transmitted by the transmitting UE 1002 as the CLI signal and indicates (explicitly or implicitly) for the transmitting UE 1002 to transmit different occasions of the CLI signal using different transmit beams, e.g., sweeping the beams for the different transmissions.

At stage 1320, the transmitting UE 1002 transmits a CLI signal 1322 to the receiving UE 1001. The transmitting UE 1002 transmits the CLI signal 1322 in multiple occasions using different transmit beams in accordance with the CLI signal configuration 1312. Referring also to FIG. 14, in an example, the transmitting UE 920 transmits an occasion 1401 of the RS that is the CLI signal 1322 using the transmit beam 921, an occasion 1402 using the transmit beam 922, and an occasion 1403 using the transmit beam 923.

At stage 1330, the receiving UE 1001 measures the multiple occasions of the CLI signal 1322 using the same receive beam of the transceiver 520. For example, the receiving UE 910 may receive the CLI signal 1322 using a default beam. As another example, the receiving UE 1001 may receive the CLI signal 1322 with a beam indicated by the CLI signal configuration 1311, or with a beam determined by the receiving UE 1001. The indicated or determined beam may be a wide beam to provide a large coverage area. As another example, the indicated or determined beam may be an optimum beam, e.g., determined in accordance with the flow 1100 discussed above, or based on historical information (e.g., a beam that was used to track a target object successfully) and/or based on position information (e.g., of the receiving UE 1001 and a target object). In the example shown in FIG. 14, the receiving UE 910 receives the occasion 1401, the occasion 1402, and the occasion 1403 using the receive beam 912. The CLI unit 550 may determine one or more measurements, e.g., RSRP, RSSI, and/or Doppler, for the CLI signal 1322 as received by the receive beam 912. The CLI unit 550 may determine, based on the measurement(s) and the repetition flag being set to OFF, to transmit, via the transceiver 520, one or more occasion indications 1332. The occasion indication(s) 1332 may, for example, indicate a best occasion corresponding to a best transmit beam (of the transmit beams used) for transmitting the CLI signal 1322. For example, the occasion indication(s) 1332 may report the occasion, of the multiple occasions of the CLI signal 1322, corresponding to a largest measured RSRP or a largest measured RSSI. As another example, the occasion indication(s) 1332 may report the occasion corresponding to a largest Doppler value. As another example, the occasion indication(s) 1332 may report the occasion corresponding to a largest measured RSRP, or largest measured RSSI, from among the occasions with non-zero Doppler value measurements. As another example, the occasion indication(s) 1132 may report all occasions with one or more corresponding measurement values (e.g., RSRP, RSSI, and/or Doppler) that exceed one or more corresponding threshold values (e.g., an RSRP threshold, an RSSI threshold, and/or a Doppler threshold). The occasion indication(s) 1332 may include, for example, an occasion index for each reported occasion and may include the measured value(s) for each reported occasion.

At stage 1340, the network entity 600, e.g., the sensing unit 660, may determine a best transmit beam to use for transmitting sensing signals. For example, the sensing unit 660 may determine a best transmit beam, of the multiple transmit beams used by the transmitting UE 1002 to send one or more sensing signals, based on the occasion indication(s) 1332 and/or other information provided by the receiving UE 1001. For example, the transmit beam selection may be based on knowledge of the location of the transmitting UE 1002 and transmit beam information of the transmitting UE 1002 (e.g., which transmit beams correspond to which CLI signal occasions and possibly which directions the various transmit beams point). The sensing unit 660 may determine (based on the reported measurements and the resource transmission pattern) which transmit beam yielded the best received signal (e.g., strongest received signal, e.g., highest-received power of received signals corresponding to multiple resources), which may correlate to the most accurate target object location, and select that transmit beam as the best transmit beam. By selecting a particular transmit beam for transmitting CLI signals, measurement accuracy of the transmitted CLI signals may be improved, which may improve sensing such as position estimate accuracy of a target object and/or speed estimate accuracy for the target object, etc. The CLI configuration unit 650 may determine the best transmit beam without a connection between the transmitting UE 1002 and the receiving UE 1001 being built (e.g., to transfer information for determining the best transmit beam). The receiving UE 1001 may not be able to determine the best transmit beam to use for sensing, e.g., because the receiving UE 1001 may not know the location of the transmitting UE 1002 and/or transmit beam information (e.g., timing of transmit beam transmissions).

Referring in particular again to FIG. 10, at stage 1030, the network entity 600 transmits a sensing signal configuration 1031 to the receiving UE 1001 and transmits a sensing signal configuration 1032 to the transmitting UE 1002. The sensing signal configurations 1031, 1032 may indicate which receive beam or beams and which transmit beam or beams, respectively, to use to receive and transmit a sensing signal (e.g., in one or more occasions and/or in one or more resources). The sensing signal configuration 1031 may, for example, indicate a receive beam selected at stage 1010 (or another selected receive beam or to use a default receive beam) and/or the sensing signal configuration 1032 may, for example, indicate a transmit beam selected at stage 1020 (or another selected transmit beam or to use a default transmit beam), or the receiving UE 1001 may use a default receive beam and/or the transmitting UE 1002 may use a default transmit beam. The sensing signal configurations 1031, 1032 may, for example, indicate to use a single receive beam and a single transmit beam. As another example, the sensing signal configurations 1031, 1032 may indicate to use a single receive beam and to change (e.g., sweep) the transmit beams, e.g., as shown in FIG. 14, or may indicate to use a single transmit beam and to change receive beams, e.g., as shown in FIG. 12. As another example, the sensing signal configuration 1031 and/or the sensing signal configuration 1032 may indicate to use multiple receive beams and/or multiple transmit beams, e.g., sweeping the beams intermittently (e.g., periodically). To do this, the sensing signal configurations 1031, 1032 may indicate the intermittent sweeping or the sensing signal configurations 1031, 1032 may be intermittently transmitted, with each of the intermittent transmissions indicating to sweep the respective beams. As another example, one or more of the sensing signal configurations 1031 may be used to indicate to use a selected receive beam at one or more times and at one or more other times to sweep receive beams (possibly in combination with sweeping of the transmit beams). Similarly, one or more of the sensing signal configuration 1032 may be used to indicate to use a selected transmit beam at one or more times and at one or more other times to sweep transmit beams (possibly in combination with sweeping of the receive beams). The sensing signal configuration 1031 may include a request for the receiving UE 1001 to report a best measurement corresponding to multiple occasions of the sensing signal. This may help ensure and/or improve sensing accuracy (e.g., target object position estimate accuracy and/or target object motion estimate accuracy) by ensuring and/or improving measurement quality. Still other sensing signal configurations may be indicated.

At stage 1040, the transmitting UE 1002 transmits the sensing signal(s) 1042 to the receiving UE 1001 in accordance with the sensing signal configuration 1032. The transmitting UE 1002 may transmit the sensing signal(s) 1042 in multiple occasions, and/or using multiple resources, and/or using a single transmit beam or multiple transmit beams, e.g., the transmit beam selected at stage 1020 or two or more of the transmit beams 921-923 as discussed herein.

At stage 1050, the receiving UE 1001 receives and measures the sensing signal(s) 1042. The receiving UE 1001 may use one or more receive beams, e.g., the receive beam selected at stage 1010 or two or more of the receive beams 911-913, to receive the sensing signal(s) 1042 for measurement. The receiving UE 1001 may report a highest value (e.g., received power or Doppler) from measurements of multiple occasions of the sensing signal(s) 1042 with the same transmit beam and different receive beams (e.g., from different occasions similar to the occasions 1201-1203). The receiving UE 1001 may report a highest value (e.g., received power or Doppler) from measurements of multiple occasions of the sensing signal(s) 1042 with the same receive beam and different transmit beams (e.g., from different occasions similar to the occasions 1401-1403). The receiving UE 1001 may determine a set of occasions with non-zero Doppler values (based on a single receive beam and multiple transmit beams, or based on a single transmit beam and multiple receive beams) and report the highest received power of the occasions with non-zero Doppler values. The receiving UE 1001 may combine (e.g., average) similar measurements of multiple occasions of the sensing signal(s) 1042, e.g., combining measurements of the occasions that are transmitted by the same transmit beam and received by the same receive beam. The receiving UE 1001, e.g., the CLI unit 550, may determine further position information (i.e., in addition to the measurement(s)), such as one or more ranges to one or more target objects, one or more target object speeds, and/or one or more target object locations, etc. The receiving UE 1001 may transmit a measurement report 1052 (e.g., raw measurement information, one or more measurements (e.g., power and/or Doppler), one or more ranges, one or more locations, an indication of an occasion with highest received power, an indication of an occasion with a highest Doppler, and indication of an occasion with highest received power and non-zero Doppler, etc.) to the network entity 600.

At stage 1060, the network entity 600, e.g., the sensing unit 660, may determine position information and/or beam information based on the measurement report 1052 received from the receiving UE 1001. For example, the network entity 600 may determine one or more measurements from raw measurement information, and/or may determine one or more ranges to one or more target objects from the receiving UE 1001, one or more target object speeds, one or more target object locations, etc. As another example, the network entity 600 (e.g., the processor 610) may determine a best transmit beam, e.g., based on an occasion with a highest received power at the receiving UE 1001, or based on an occasion with a highest Doppler value at the receiving UE 1001, or based on an occasion with a highest received power from occasions with non-zero Doppler values. As another example, the network entity 600 may determine a best receive beam, e.g., as discussed with respect to stage 1130.

At stage 1070, the network entity 600 may transmit a measurement report 1071 to the transmitting UE 1002 for determining a best transmit beam. The measurement report 1071 may include an indication of an occasion with a highest received power, an indication of an occasion with a highest Doppler value, an indication of an occasion with a highest received power from occasions with non-zero Doppler values, and/or one or more other indications such as one or more measurements (e.g., indications of multiple occasions and respective received powers and/or respective Doppler values). At sub-stage 1072, the transmitting UE 1002 (e.g., the sensing unit 560) may use information from the measurement report 1071 (e.g., one or more measurements) to determine the best transmit beam (e.g., based on an occasion with a highest received power at the receiving UE 1001, or based on an occasion with a highest Doppler value at the receiving UE 1001, or based on an occasion with a highest received power from occasions with non-zero Doppler values).

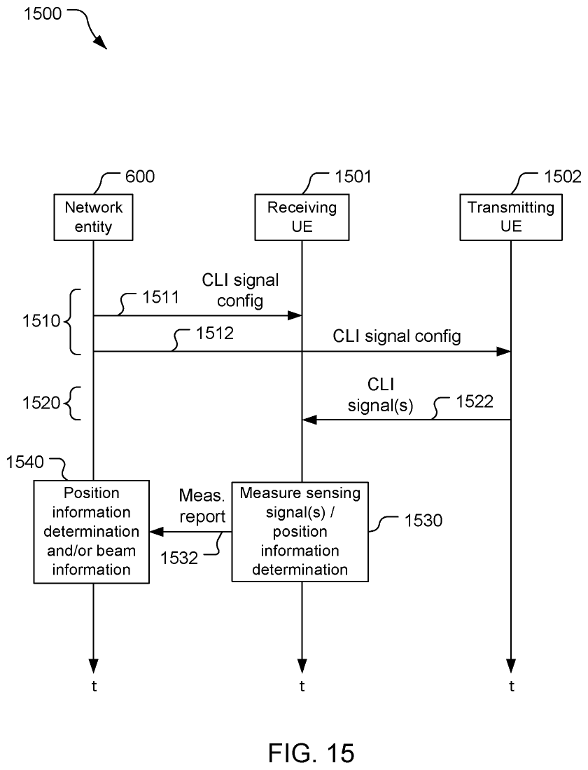

Referring to FIG. 15, a processing and signal flow 1500 for multi-directional sensing (multi-directional coverage) includes the stages shown. The flow 1500 is an example, and stages may be added to, removed from, and/or rearranged in, the flow 1500. The flow 1500 leverages a CLI procedure for RF sensing.

At stage 1510, the network entity 600, e.g., the CLI configuration unit 650, transmits a CLI configuration 1511 to a receiving UE 1501 (e.g., the receiving UE 910) and a CLI signal configuration 1512 to a transmitting UE 1502 (e.g., the transmitting UE 920). The CLI configuration 1511 indicates one or more configurations of one or more uplink CLI signals to be measured by the receiving UE 1501, e.g., SRS resources of multiple occasions of the uplink CLI signal to be measured by the CLI unit 550. The CLI configuration 1511 may include a repetition flag set to an “ON” value indicating that the same transmit beam will be used by the transmitting UE 1502 to transmit the multiple occasions of the CLI signal. The CLI signal configuration 1512 indicates one or more configurations of one or more uplink reference signals (RS) to be transmitted by the transmitting UE 1502.

At stage 1520, the transmitting UE 1502 transmits one or more CLI signals 1522 to the receiving UE 1501. The transmitting UE 1502 transmits the CLI signal(s) 1522 in one or more occasions using one or more transmit beams in accordance with the CLI signal configuration 1512 (e.g., as indicated by the CLI signal configuration 1512 or determined by the transmitting UE 1502). For example, the transmitting UE 920 may transmit the CLI signal(s) 1522 with the transmit beam 921, or the transmit beam 922, and/or a transmit beam 923. The transmitting UE 920 may, for example, transmit the CLI signal(s) 1122 using a default beam, one or more beams indicated by the CLI signal configuration 1512, or one or more beams determined by the transmitting UE 1502. The receiving UE 1501 may receive the CLI signal(s) 1522 with one or more receive beams, e.g., a default beam, one or more beams indicated by the CLI signal configuration 1511, or one or more beams determined by the receiving UE 1501.

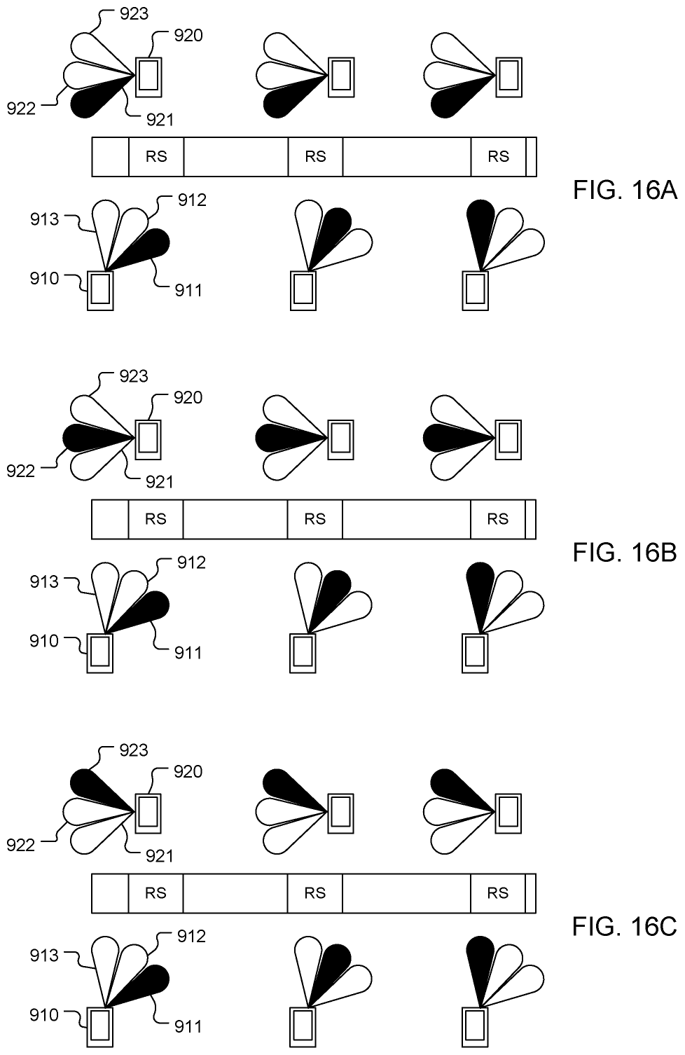

The CLI signal configurations 1511, 1512 may provide for multi-directional coverage using a CLI procedure (transmitting and receiving one or more CLI signals), e.g., coverage in all directions coverable by the receiving UE 1501 and/or the transmitting UE 1502. For example, referring also to FIG. 16A, FIG. 16B, and FIG. 16C, the CLI signal configuration 1512 may cause the transmitting UE 1502 to transmit the CLI signal(s) 1522 with each of multiple beams, e.g., to cause the transmitting UE 920 to transmit the CLI signal(s) with the beam 921 as shown in FIG. 16A, with the beam 922 as shown in FIG. 16B, and with the beam 923 as shown in FIG. 16C. For each transmit beam, the CLI signal configuration 1511 may cause the receiving UE 1501 to receive the CLI signal(s) with multiple beams, e.g., causes the receiving UE 910 to receive the CLI signal(s) with the receive beams 911-913 (with different receive beams for different CLI signal occasions or different CLI signals) as shown in each of FIGS. 16A-16C. Alternatively, the CLI signal configurations 1511, 1512 may cause the receiving UE 1501 to receive a CLI signal(s) with multiple receive beams and for each of the receive beams, to cause the transmitting UE 1502 to transmit the CLI signal(s) with each of multiple transmit beams (e.g., sweep the transmit beams). Alternatively still, combinations of these techniques may be used, e.g., changing receive beams for each transmit beam in one or more time windows and changing transmit beams for each receive beam in one or more other time windows. Alternatively still, multi-direction sensing may be used at one or more times, and single-direction sensing (e.g., one transmit beam and one receive beam) may be used at one or more other times. By changing the transmit beams and/or the receive beams, more directions may be sensed (e.g., a broader area covered for sensing) compared to using a single selected transmit beam and/or a single selected receive beam. For example, changing the transmit beams and/or the receive beams may help cover an entire room for object sensing. For multi-directional coverage, the CLI signal configuration 1511 sent to the receiving UE 1501 may include the transmit beam pattern (i.e., the sequence of transmit beams). The CLI resources indicated in the CLI signal configuration 1511 are associated with the transmit beams in the transmit beam pattern by the network entity 600, e.g., the CLI configuration unit 650. Providing multi-directional sensing coverage using the CLI signal(s) may improve sensing, e.g., by providing sensing of target objects in a broader coverage area than using a single transmit beam and a single receive beam, may allow for sensing of more target objects, and/or may provide more accurate measurements (e.g., due to using beams better directed at target objects) which may result in more accurate sensing (e.g., more accurate position estimates of target objects and/or more accurate speed estimates of target objects).

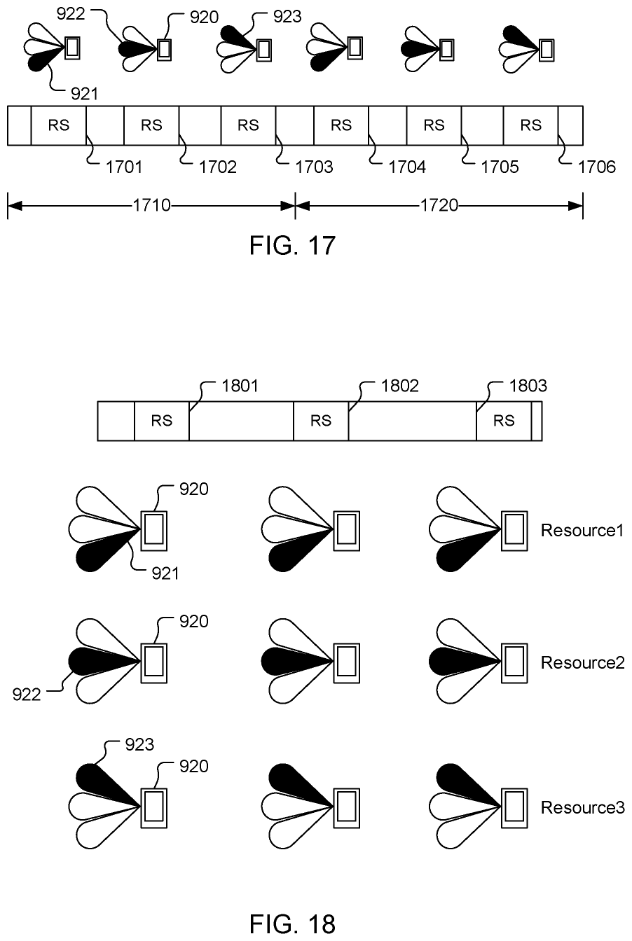

Referring also to FIG. 17, as an example for multi-directional coverage, the CLI signal configuration 1512 may configure the transmitting UE 1502 to transmit the CLI signal(s) in multiple beams, with different transmit beams used in different occasions of a CLI signal and/or for occasions of different CLI signals. In this example, the transmitting UE 920 transmits the CLI signal(s) in occasions 1701, 1702, 1703, 1704, 1705, 1706 that are in cycles 1710, 1720, with three of the occasions 1701-1706 in each of the cycles 1710, 1720. In each of the cycles 1710, 1720, the transmitting UE 920 transmits the CLI signal(s) in each of the transmit beams 921, 922, 923, with the transmit beam 921 used for the occasions 1701, 1704, the transmit beam 922 used for the occasions 1702, 1705, and the transmit beam 923 used for the occasions 1703, 1706. The receiving UE 1501 is configured with the transmit beam pattern by the network entity 600 via the CLI signal configuration 1511. The transmit beam pattern may be determined by the network entity 600. Alternatively, the transmitting UE 1502 may determine the transmit beam pattern and provide the transmit beam pattern to the network entity 600 that can then provide the transmit beam pattern to the receiving UE 1501. Any of a variety of transmit beam patterns may be used. In the example shown in FIG. 17, a beam index pattern of 0/1/2/0/1/2 is used indicating that three transmit beams are used in each of the cycles 1710, 1720 in the order of beam index 0 (corresponding to the transmit beam 921), beam index 1 (corresponding to the transmit beam 922), and beam index 2 (corresponding to the transmit beam 923). As another example, one transmit beam may be used for each cycle of multiple (e.g., three) occasions with different transmit beams used in different cycles. Still other transmit beam patterns may be used.

Referring also to FIG. 18, as another example for multi-directional coverage, the CLI signal configuration 1512 may configure the transmitting UE 1502 to transmit the CLI signal(s) in multiple beams, with different transmit beams used for different resources in each of multiple occasions. In this example, the transmitting UE 920 transmits the CLI signal(s) using a different resource for each of the transmit beams 921-923 in each occasion 1801, 1802, 1803. The CLI signal configuration 1511 and the CLI signal configuration 1512 configure an RS resource set of the CLI signal(s) to the receiving UE 1501 and the transmitting UE 1502, respectively. The CLI signal configuration 1511 may configure the receiving UE 1501 with a respective receive beam for each resource, or may configure one receive beam for all the resources, or may configure one or more receive beams for one resource each and/or one or more other receive beams for two or more resources each. The receiving UE 1501 measures the multiple received RS resources from the transmitting UE 1502 and determines the best measurement (e.g., the highest received power) to determine the best RS resource. Because each of the RS resources is mapped to a respective one of the transmit beams 921-923, the best of the transmit beams 921-923 can be determined as the transmit beam that maps to the RS resource determined to yield the best RS resource measurement.

For multi-directional coverage, the network entity 600 (e.g., the CLI configuration unit 650) will typically determine the receive beam(s) and the transmit beam(s) to use. The network entity 600 may cause intermittent use (e.g., sweeping) of multiple receive beams and/or intermittent use (e.g., sweeping) of multiple transmit beams. For example, multi-directional sensing may be performed intermittently with or without non-multi-directional sensing in between consecutive performances of the multi-directional sensing. The intermittent multi-directional sensing may be periodic, and thus at regular intervals. With multi-directional coverage, with a rough knowledge of a transmit beam pattern, the receiving UE 1501 may extract a sensing feature, e.g., for use in one or more applications.

Referring again in particular to FIG. 15, at stage 1530, the receiving UE 1501 measures the CLI signal(s) 1522. The receiving UE 1501 may use one or more receive beams to measure the CLI signal(s) 1522 from one or more transmit beams. The sensing unit 560 may determine position information (e.g., one or more measurements and/or processed measurement information such as one or more combinations of measurements, one or more ranges, one or more position estimates, etc.) such as discussed with respect to stage 1050. The receiving UE 1501 may provide a measurement report 1532 with position information to the network entity 600.

At stage 1540, the network entity 600, e.g., the sensing unit 660, may determine position information and/or beam information based on the measurement report 1532 received from the receiving UE 1501. For example, the network entity 600 may determine position information as discussed with respect to stage 1060.

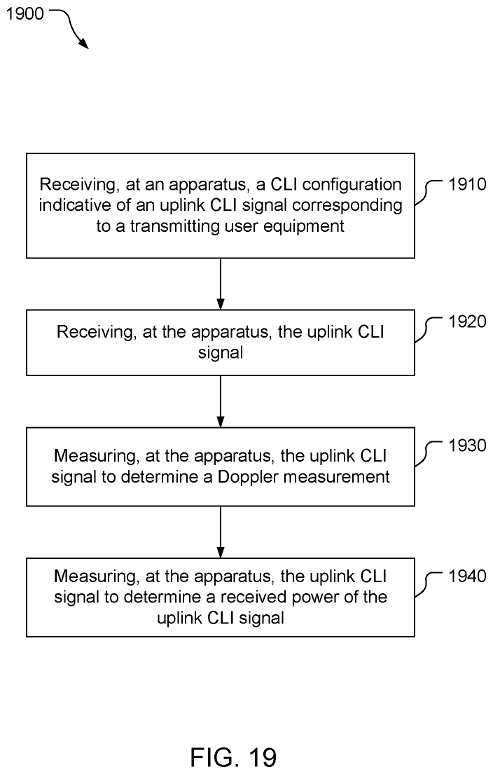

Referring to FIG. 19, with further reference to FIGS. 1-17, a method 1900 for CLI signal measurement includes the stages shown. The method 1900 is, however, an example and not limiting. The method 1900 may be altered, e.g., by having stages added, removed, rearranged, combined, performed concurrently, and/or having single stages split into multiple stages.

At stage 1910, the method 1900 includes receiving, at an apparatus, a CLI configuration indicative of an uplink CLI signal corresponding to a transmitting user equipment. For example, at stage 1030 or stage 1110, the receiving UE 1001, e.g., the CLI unit 550, receives the sensing signal configuration 1031, 1111 for receiving the uplink CLI signal(s) 1042, 1122 from the transmitting UE 1002. The processor 510, possibly in combination with the memory 530, in combination with the transceiver 520 (e.g., the wireless receiver 244 and the antenna 246) may comprise means for receiving the CLI configuration. While the receiving UE 1001 is discussed as an example of the apparatus, other forms of the apparatus may be used, e.g., a base station.

At stage 1920, the method 1900 includes receiving, at the apparatus, the uplink CLI signal. For example, at stage 1040 or stage 1120, the receiving UE 1001, e.g., the CLI unit 550, receives the uplink CLI signal(s) 1042, 1122 from the transmitting UE 1002. The processor 510, possibly in combination with the memory 530, in combination with the transceiver 520 (e.g., the wireless receiver 244 and the antenna 246) may comprise means for receiving the uplink CLI signal.

At stage 1930, the method 1900 includes measuring, at the apparatus, the uplink CLI signal to determine a Doppler measurement. For example, at stage 1050 or stage 1130, the receiving UE 1001, e.g., the CLI unit 550, measures the uplink CLI signal(s) 1042, 1122 to determine a Doppler value (e.g., for each of the uplink CLI signal(s) 1042, 1122 such as each occasion of the uplink CLI signal(s) 1042, 1122). The processor 510, possibly in combination with the memory 530, may comprise means for measuring the uplink CLI signal to determine the Doppler measurement.

At stage 1940, the method 1900 includes measuring, at the apparatus, the uplink CLI signal to determine a received power of the uplink CLI signal. For example, at stage 1050 or stage 1130, the receiving UE 1001, e.g., the CLI unit 550, measures the uplink CLI signal(s) 1042, 1122 to determine a received power value (e.g., and RSRP for each of the uplink CLI signal(s) 1042, 1122 such as each occasion of the uplink CLI signal(s) 1042, 1122). The processor 510, possibly in combination with the memory 530, may comprise means for measuring the uplink CLI signal to determine the received power of the uplink CLI signal.

Implementations of the method 1900 may include one or more of the following features. In an example implementation, the method 1900 includes determining a best receive beam, of a plurality of receive beams of the apparatus, for receiving the uplink CLI signal. For example, the receiving UE 1001, e.g., the CLI unit 550, may determine which of multiple receive beams of the receiving UE 1001 (e.g., which of the receive beams 911-913 of the receiving UE 910) is a best receive beam (e.g., yields the strongest measurement(s) of the receive beams 911-913, e.g., as discussed with respect to stage 1130 and FIG. 12). The processor 510, possibly in combination with the memory 530, may comprise means for determining the best receive beam. In a further example implementation, receiving the uplink CLI signal comprises receiving the uplink CLI signal with each of the plurality of receive beams, measuring the uplink CLI signal comprises measuring the uplink CLI signal received by each of the plurality of receive beams to determine a plurality of measurements, and the method 1900 includes: determining, based on the plurality of measurements, the best receive beam from the plurality of receive beams; and receiving a radio frequency sensing signal using the best receive beam from the plurality of receive beams. For example, as discussed with respect to FIGS. 11 and 12, the CLI unit 550 measures the CLI signal 1122 using the receive beams 911-913 and determines the best of the receive beams 911-913 based on the measurements obtained using each of the receive beams 911-913. At stage 1040, the receiving UE 1001 receives the sensing signal(s) 1042 using the determined best receive beam. The processor 510, possibly in combination with the memory 530, in combination with the transceiver 520 (e.g., the wireless receiver 244 and the antenna 246) may comprise means for receiving the uplink CLI signal with each of the plurality of receive beams. The processor 510, possibly in combination with the memory 530, may comprise means for measuring the uplink CLI signal received by each of the plurality of receive beams. The processor 510, possibly in combination with the memory 530, may comprise means for determining the best receive beam based on the plurality of measurements. The processor 510, possibly in combination with the memory 530, in combination with the transceiver 520 (e.g., the wireless receiver 244 and the antenna 246) may comprise means for receiving the RF sensing signal using the best receive beam. In a further example implementation, determining the best receive beam comprises determining which of the plurality of receive beams corresponds to a highest received power of the plurality of measurements. For example, the CLI unit 550 of the receiving UE 910 may select whichever of the receive beams 911-913 yielded the highest power measurement as the best receive beam. In another further example implementation, determining the best receive beam comprises determining which of the plurality of receive beams corresponds to a highest Doppler value of the plurality of measurements. For example, the CLI unit 550 of the receiving UE 910 may select whichever of the receive beams 911-913 yielded the highest Doppler value as the best receive beam. In another further example implementation, determining the best receive beam includes: determining a set of one or more of the plurality of receive beams that each correspond to a non-zero Doppler value of the plurality of measurements; and determining which of the set of one or more of the plurality of receive beams corresponds to a highest received power of the plurality of measurements. For example, the CLI unit 550 of the receiving UE 910 determines which receive beams yielded non-zero Doppler values and selects, from those receive beams, the receive beam that yielded the highest received power as the best receive beam. The processor 510, possibly in combination with the memory 530, may comprise means for determining the set of one or more of the plurality of receive beams that each correspond to a non-zero Doppler value and means for determining which of the set of one or more of the plurality of receive beams corresponds to a highest received power.

Also or alternatively, implementations of the method 1900 may include one or more of the following features. In an example implementation, receiving the uplink CLI signal comprises receiving a plurality of occasions of the uplink CLI signal via a single receive beam of the apparatus, measuring the uplink CLI signal comprises measuring the plurality of occasions of the uplink CLI signal to determine a plurality of measurements, and the method 1900 includes transmitting, from the apparatus to a network entity, a measurement report indicating which of the plurality of occasions of the uplink CLI signal corresponds to a highest received power of the plurality of measurements. For example, at stages 1040, 1050, the receiving UE 1001 may receive and measure the uplink CLI signal(s) 1042, e.g., in occasions similar to the occasions 1401-1403, from the transmit beams 921-923. The receiving UE 1001 may send, at stage 1050, the measurement report 1052 indicating which of the occasions yielded a highest received power measurement. The processor 510, possibly in combination with the memory 530, in combination with the transceiver 520 (e.g., the wireless receiver 244 and the antenna 246) may comprise means for receiving the plurality of occasions of the uplink CLI signal. The processor 510, possibly in combination with the memory 530, may comprise means for measuring the plurality of occasions of the uplink CLI signal to determine the plurality of measurements. The processor 510, possibly in combination with the memory 530, in combination with the transceiver 520 (e.g., the wireless transmitter 242 and the antenna 246) may comprise means for transmitting the measurement report. In another example implementation, the measurement report indicates which of the plurality of occasions of the uplink CLI signal corresponds to a highest Doppler value of the plurality of measurements.

Also or alternatively, implementations of the method 1900 may include one or more of the following features. In an example implementation, receiving the uplink CLI signal comprises receiving a plurality of occasions of the uplink CLI signal via a single receive beam of the apparatus, measuring the uplink CLI signal comprises measuring the plurality of occasions of the uplink CLI signal to determine a plurality of measurements, and the method 1900 includes: determining a set of one or more of the plurality of occasions that each corresponds to a non-zero Doppler value of the plurality of measurements; and transmitting, from the apparatus to a network entity, a measurement report indicating which of the set of one or more of the plurality of occasions corresponds to a highest received power of the plurality of measurements. For example, from the measurements of the occasions of the uplink CLI signal(s) 1042, e.g., in occasions similar to the occasions 1401-1403, the receiving UE 1001 (e.g., the CLI unit 550) may determine which occasions correspond to non-zero Doppler measurements and report, from those occasions in the measurement report 1052, the occasion that yielded the highest received power. The processor 510, possibly in combination with the memory 530, may comprise means for determining the set of one or more of the plurality of occasions that each correspond to a non-zero Doppler value. The processor 510, possibly in combination with the memory 530, in combination with the transceiver 520 (e.g., the wireless transmitter 242 and the antenna 246) may comprise means for transmitting the measurement report.

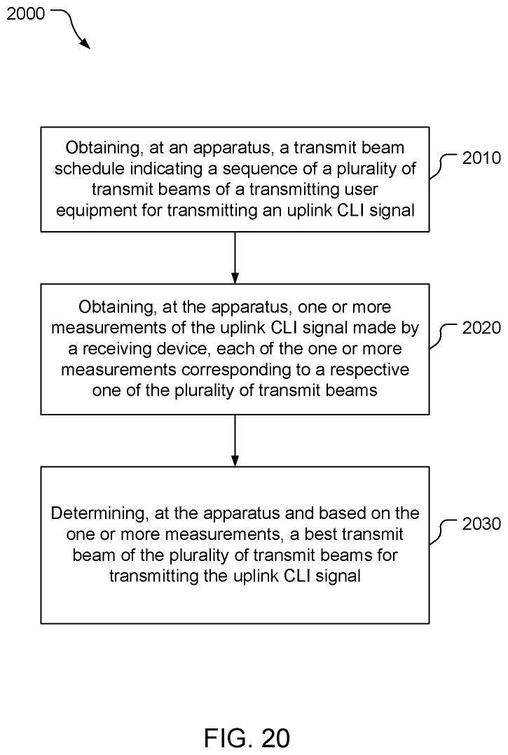

Referring to FIG. 20, with further reference to FIGS. 1-17, a method 2000 for beam management includes the stages shown. The method 2000 is, however, an example and not limiting. The method 2000 may be altered, e.g., by having stages added, removed, rearranged, combined, performed concurrently, and/or having single stages split into multiple stages.

At stage 2010, the method 2000 includes obtaining, at an apparatus, a transmit beam schedule indicating a sequence of a plurality of transmit beams of a transmitting user equipment for transmitting an uplink CLI signal. For example, the network entity 600 (e.g., the CLI configuration unit 650) obtains a transmit beam schedule by retrieving the transmit beam schedule from the memory 630 or determining the transmit beam schedule. The processor 610, possibly in combination with the memory 630, may comprise means for obtaining the transmit beam schedule. As another example, the transmitting UE 1002 (e.g., the CLI unit 550) receives the transmit beam schedule from the network entity 600 in the sensing signal configuration 1032. The processor 510, possibly in combination with the memory 530, in combination with the transceiver 520 (e.g., the wireless receiver 244 and the antenna 246) may comprise means for obtaining the transmit beam schedule.

At stage 2020, the method 2000 includes obtaining, at the apparatus, one or more measurements of the uplink CLI signal made by a receiving device, each of the one or more measurements corresponding to a respective one of the plurality of transmit beams. For example, the network entity 600 receives the measurement report 1052 from the receiving UE 1001, with the measurement report 1052 including one or more measurements (e.g., one or more Doppler values and/or one or more received power values) corresponding to each of the transmit beams for transmitting the uplink CLI signal, e.g., the uplink CLI signal(s) 1042. The processor 610, possibly in combination with the memory 630, in combination with the transceiver 620 (e.g., the wireless receiver 344 and the antenna 346, and/or the wireless receiver 444 and the antenna 446, and/or the wired receiver 454) may comprise means for obtaining the one or more measurement of the uplink CLI signal. As another example, the transmitting UE 1002 may receive the one or more measurements from the network entity 600 in the measurement report 1071. The processor 510, possibly in combination with the memory 530, in combination with the transceiver 520 (e.g., the wireless receiver 244 and the antenna 246) may comprise means for obtaining the one or more measurements of the uplink CLI signal.

At stage 2030, the method 2000 includes determining, at the apparatus and based on the one or more measurements, a best transmit beam of the plurality of transmit beams for transmitting the uplink CLI signal. For example, at stage 1060, the network entity 600 may determine the best transmit beam of the transmitting UE 1002, which may help improve and/or ensure sensing accuracy. The processor 610, possibly in combination with the memory 630, may comprise means for determining the best transmit beam. As another example, at stage 1070, the transmitting UE 1002 may determine the best transmit beam of the transmitting UE 1002, which may help improve and/or ensure sensing accuracy. The processor 510, possibly in combination with the memory 530, may comprise means for determining the best transmit beam.

Implementations of the method 2000 may include one or more of the following features. In an example implementation, the one or more measurements comprise a plurality of measurements and determining the best transmit beam comprises determining which of the plurality of transmit beams corresponds to a highest received power of the plurality of measurements. In another example implementation, the one or more measurements comprise a plurality of measurements and determining the best transmit beam comprises determining which of the plurality of transmit beams corresponds to a highest Doppler value of the plurality of measurements. In another example implementation, the one or more measurements comprise a plurality of measurements and determining the best transmit beam comprises: determining a set of one or more of the plurality of transmit beams that each correspond to a non-zero Doppler value of the plurality of measurements; and determining which of the set of one or more of the plurality of transmit beams corresponds to a highest received power of the plurality of measurements. For example, the network entity 600 and/or the transmitting UE 1002 may determine which transmit beam(s) has a corresponding non-zero Doppler value measurement (of the corresponding received signal) and determine the best transmit beam as the transmit beam, of the transmit beam(s) with corresponding non-zero Doppler values, that has the highest corresponding power measurement (of the corresponding received signal). The processor 610, possibly in combination with the memory 630, and/or the processor 510, possibly in combination with the memory 530, may comprise means for determining the set of one or more of the plurality of transmit beams that each correspond to a non-zero Doppler value. The processor 610, possibly in combination with the memory 630, and/or the processor 510, possibly in combination with the memory 530, may comprise means for determining which of the set of one or more of the plurality of transmit beams corresponds to a highest received power of the plurality of measurements.

Also or alternatively, implementations of the method 2000 may include one or more of the following features. In an example implementation, the method 2000 includes determining the transmit beam schedule; transmitting the transmit beam schedule to the transmitting user equipment; transmitting, to a receiving user equipment, a receive schedule indicating a plurality of signal occasions for measuring the uplink CLI signal; and transmitting, to the receiving device, a request to report a best measurement corresponding to the plurality of signal occasions. For example, at stage 1030, the network entity 600 (e.g., the CLI configuration unit 650) may determine the transmit beam schedule (e.g., based on a determined best transmit beam and/or one or more other considerations such as desired coverage area, estimated location of the transmitting UE 1002, estimated location of the receiving UE 1001, estimated location of a target object, etc.). The processor 610, possibly in combination with the memory 630, may comprise means for determining the transmit beam schedule. Also at stage 1030, the network entity 600 may transmit the beam schedule to the transmitting UE 1002 in the sensing signal configuration 1032. The processor 610, possibly in combination with the memory 630, in combination with the transceiver 620 (e.g., the wireless transmitter 342 and the antenna 346, and/or the wired transmitter 352, or the wireless transmitter 442 and the antenna 446) may comprise means for transmitting the transmit beam schedule. Also at stage 1030, the network entity 600 may transmit the receive schedule to the receiving UE 1001 in the sensing signal configuration 1031 to schedule occasions at the receiving UE 1001 to receive and measure the uplink CLI signal. The processor 610, possibly in combination with the memory 630, in combination with the transceiver 620 (e.g., the wireless transmitter 342 and the antenna 346, and/or the wired transmitter 352, or the wireless transmitter 442 and the antenna 446) may comprise means for transmitting the receive schedule. Also at stage 1030, the network entity 600 may transmit the request to report the best measurement to the receiving UE 1001 in the sensing signal configuration 1031. The processor 610, possibly in combination with the memory 630, in combination with the transceiver 620 (e.g., the wireless transmitter 342 and the antenna 346, and/or the wired transmitter 352, or the wireless transmitter 442 and the antenna 446) may comprise means for transmitting the request to report the best measurement.

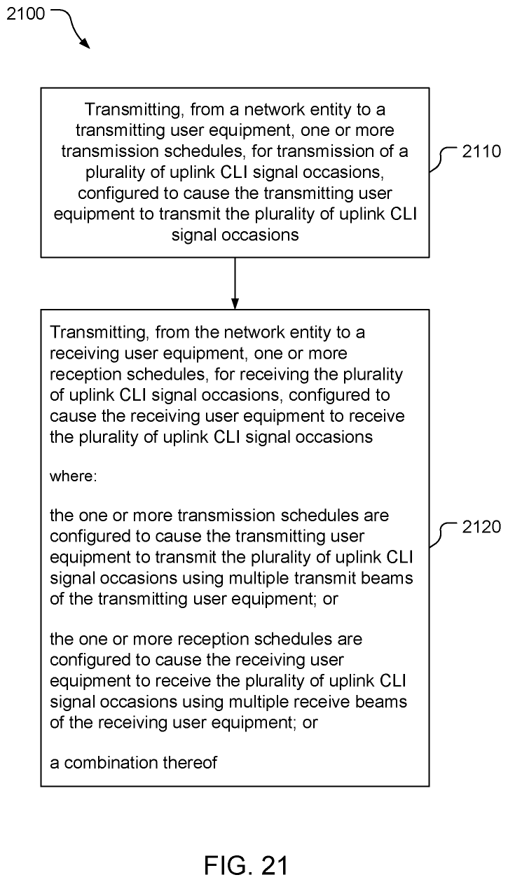

Referring to FIG. 21, with further reference to FIGS. 1-18, a method 2100 for sensing signal scheduling includes the stages shown. The method 2100 is, however, an example and not limiting. The method 2100 may be altered, e.g., by having stages added, removed, rearranged, combined, performed concurrently, and/or having single stages split into multiple stages.

At stage 2110, the method 2100 includes transmitting, from a network entity to a transmitting user equipment, one or more transmission schedules, for transmission of a plurality of uplink CLI signal occasions, configured to cause the transmitting user equipment to transmit the plurality of uplink CLI signal occasions. For example, at stage 1510, the network entity 600 (e.g., the CLI configuration unit 650) transmits the CLI signal configuration 1512 to the transmitting UE 1502 with one or more transmission schedules for transmitting the uplink CLI signal(s) 1522. The processor 610, possibly in combination with the memory 630, in combination with the transceiver 620 (e.g., the wireless transmitter 342 and the antenna 346, and/or the wired transmitter 352, or the wireless transmitter 442 and the antenna 446) may comprise means for transmitting the one or more transmission schedules.

At stage 2120, the method 2100 includes transmitting, from the network entity to a receiving user equipment, one or more reception schedules, for receiving the plurality of uplink CLI signal occasions, configured to cause the receiving user equipment to receive the plurality of uplink CLI signal occasions. For example, at stage 1510, the network entity 600 (e.g., the CLI configuration unit 650) transmits the CLI signal configuration 1511 to the receiving UE 1501 with one or more reception schedules for receiving the uplink CLI signal(s) 1522. The processor 610, possibly in combination with the memory 630, in combination with the transceiver 620 (e.g., the wireless transmitter 342 and the antenna 346, and/or the wired transmitter 352, or the wireless transmitter 442 and the antenna 446) may comprise means for transmitting the one or more reception schedules. The one or more transmission schedules are configured to cause the transmitting user equipment to transmit the plurality of uplink CLI signal occasions using multiple transmit beams of the transmitting user equipment; or the one or more reception schedules are configured to cause the receiving user equipment to receive the plurality of uplink CLI signal occasions using multiple receive beams of the receiving user equipment: or a combination thereof. For example, the transmission schedule(s) and/or the reception schedule(s) may cause the transmitting UE 1502 to sweep transmit beams to transmit the uplink CLI signal(s) and/or cause the receiving UE 1501 to sweep receive beams to receive the uplink CLI signal(s), e.g., as discussed with respect to FIGS. 16A-16C, FIG. 17, or FIG. 18, to provide multi-direction coverage.

Implementations of the method 2100 may include one or more of the following features. In an example implementation, the one or more transmission schedules and the one or more reception schedules are configured such that the receiving user equipment will receive the plurality of uplink CLI signal occasions with the multiple receive beams for each of the multiple transmit beams. For example, as shown in FIGS. 16A-16C, for each of the transmit beams 921-923, each of the receive beams 911-913 is used to receive the uplink CLI signal(s) 1522. In another example implementation, the one or more transmission schedules are configured to cause the transmitting user equipment to intermittently repeat transmitting the plurality of uplink CLI signal occasions using the multiple transmit beams, or the one or more reception schedules are configured to cause the receiving user equipment to intermittently repeat receiving the plurality of uplink CLI signal occasions using the multiple receive beams, or a combination thereof. For example, the transmit beams 921-923 may be swept intermittently (e.g., periodically) with or without using a single transmit beam for one or more receive beam measurements between sweeps of the transmit beams 921-923, and/or with or without using a single transmit beam and a single receive beam for multiple uplink CLI signal transmissions and receptions between sweeps of the transmit beams 921-923. As another example, the receive beams 911-913 may be swept intermittently (e.g., periodically) with or without using a single receive beam for one or more receive beam measurements from transmissions from multiple transmit beams between sweeps of the receive beams 911-913, and/or with or without using a single transmit beam and a single receive beam for multiple uplink CLI signal transmissions and receptions between sweeps of the receive beams 911-913. Transmitting or receiving the uplink CLI signal occasions may be of the same uplink CLI signal or different uplink CLI signals (e.g., with different resources, different resource elements, etc.).

### IMPLEMENTATION EXAMPLES

Implementation examples are provided in the following numbered clauses.

Clause 1. An apparatus comprising:
a receiver;
a memory; and
a processor, communicatively coupled to the receiver and the memory, configured to:
   receive, via the receiver, a cross-link interference (CLI) configuration indicative of an uplink CLI signal corresponding to a transmitting user equipment;
   receive, via the receiver, the uplink CLI signal;
   measure the uplink CLI signal to determine a Doppler measurement; and
   measure the uplink CLI signal to determine a received power of the uplink CLI signal.

Clause 2. The apparatus of clause 1, wherein the processor is further configured to determine a best receive beam, of a plurality of receive beams of the receiver, for receiving the uplink CLI signal.

Clause 3. The apparatus of clause 2, wherein the receiver is configured to receive the uplink CLI signal with each of the plurality of receive beams, and wherein the processor is further configured to:
measure the uplink CLI signal received by each of the plurality of receive beams to determine a plurality of measurements;
determine, based on the plurality of measurements, the best receive beam from the plurality of receive beams; and
receive a radio frequency sensing signal using the best receive beam from the plurality of receive beams.

Clause 4. The apparatus of clause 3, wherein to determine the best receive beam the processor is further configured to determine which of the plurality of receive beams corresponds to a highest received power of the plurality of measurements.

Clause 5. The apparatus of clause 3, wherein to determine best receive beam the processor is further configured to determine which of the plurality of receive beams corresponds to a highest Doppler value of the plurality of measurements.

Clause 6. The apparatus of clause 3, wherein to determine the best receive beam the processor is further configured to:
determine a set of one or more of the plurality of receive beams that each correspond to a non-zero Doppler value of the plurality of measurements; and
determine which of the set of one or more of the plurality of receive beams corresponds to a highest received power of the plurality of measurements.

Clause 7. The apparatus of clause 1, further comprising a transmitter, wherein the processor is further configured to:
receive a plurality of occasions of the uplink CLI signal via a single receive beam of the receiver;
measure the plurality of occasions of the uplink CLI signal to determine a plurality of measurements; and
transmit, via the transmitter to a network entity, a measurement report indicating which of the plurality of occasions of the uplink CLI signal corresponds to a highest received power of the plurality of measurements.

Clause 8. The apparatus of clause 1, further comprising a transmitter, wherein the processor is further configured to:
receive a plurality of occasions of the uplink CLI signal via a single receive beam of the receiver;
measure the plurality of occasions of the uplink CLI signal to determine a plurality of measurements; and
transmit, via the transmitter to a network entity, a measurement report indicating which of the plurality of occasions of the uplink CLI signal corresponds to a highest Doppler value of the plurality of measurements.

Clause 9. The apparatus of clause 1, further comprising a transmitter, wherein the processor is further configured to:
receive a plurality of occasions of the uplink CLI signal via a single receive beam of the receiver;
measure the plurality of occasions of the uplink CLI signal to determine a plurality of measurements;
determine a set of one or more of the plurality of occasions that each corresponds to a non-zero Doppler value of the plurality of measurements; and
transmit, via the transmitter to a network entity, a measurement report indicating which of the set of one or more of the plurality of occasions corresponds to a highest received power of the plurality of measurements.

Clause 10. A method for CLI signal measurement (cross-link interference signal measurement), the method for CLI signal measurement comprising:
receiving, at an apparatus, a CLI configuration indicative of an uplink CLI signal corresponding to a transmitting user equipment;
receiving, at the apparatus, the uplink CLI signal;
measuring, at the apparatus, the uplink CLI signal to determine a Doppler measurement; and
measuring, at the apparatus, the uplink CLI signal to determine a received power of the uplink CLI signal.

Clause 11. The method for CLI signal measurement of clause 10, further comprising determining a best receive beam, of a plurality of receive beams of the apparatus, for receiving the uplink CLI signal.

Clause 12. The method for CLI signal measurement of clause 11, wherein:
receiving the uplink CLI signal comprises receiving the uplink CLI signal with each of the plurality of receive beams;
measuring the uplink CLI signal comprises measuring the uplink CLI signal received by each of the plurality of receive beams to determine a plurality of measurements; and
the method for CLI signal measurement further comprises:
   determining, based on the plurality of measurements, the best receive beam from the plurality of receive beams; and
   receiving a radio frequency sensing signal using the best receive beam from the plurality of receive beams.

Clause 13. The method for CLI signal measurement of clause 12, wherein determining the best receive beam comprises determining which of the plurality of receive beams corresponds to a highest received power of the plurality of measurements.

Clause 14. The method for CLI signal measurement of clause 12, wherein determining the best receive beam comprises determining which of the plurality of receive beams corresponds to a highest Doppler value of the plurality of measurements.

Clause 15. The method for CLI signal measurement of clause 12, wherein determining the best receive beam comprises:
determining a set of one or more of the plurality of receive beams that each correspond to a non-zero Doppler value of the plurality of measurements; and
determining which of the set of one or more of the plurality of receive beams corresponds to a highest received power of the plurality of measurements.

Clause 16. The method for CLI signal measurement of clause 10, wherein:
receiving the uplink CLI signal comprises receiving a plurality of occasions of the uplink CLI signal via a single receive beam of the apparatus;
measuring the uplink CLI signal comprises measuring the plurality of occasions of the uplink CLI signal to determine a plurality of measurements; and
the method for CLI signal measurement further comprises transmitting, from the apparatus to a network entity, a measurement report indicating which of the plurality of occasions of the uplink CLI signal corresponds to a highest received power of the plurality of measurements.

Clause 17. The method for CLI signal measurement of clause 10, wherein:
receiving the uplink CLI signal comprises receiving a plurality of occasions of the uplink CLI signal via a single receive beam of the apparatus;
measuring the uplink CLI signal comprises measuring the plurality of occasions of the uplink CLI signal to determine a plurality of measurements; and
the method for CLI signal measurement further comprises transmitting, from the apparatus to a network entity, a measurement report indicating which of the plurality of occasions of the uplink CLI signal corresponds to a highest Doppler value of the plurality of measurements.

Clause 18. The method for CLI signal measurement of clause 10, wherein:
receiving the uplink CLI signal comprises receiving a plurality of occasions of the uplink CLI signal via a single receive beam of the apparatus;
measuring the uplink CLI signal comprises measuring the plurality of occasions of the uplink CLI signal to determine a plurality of measurements; and
the method for CLI signal measurement further comprises:
   determining a set of one or more of the plurality of occasions that each corresponds to a non-zero Doppler value of the plurality of measurements; and
   transmitting, from the apparatus to a network entity, a measurement report indicating which of the set of one or more of the plurality of occasions corresponds to a highest received power of the plurality of measurements.

Clause 19. An apparatus comprising:
means for receiving a CLI (cross-link interference) configuration indicative of an uplink CLI signal corresponding to a transmitting user equipment;
means for receiving the uplink CLI signal;
means for measuring the uplink CLI signal to determine a Doppler measurement; and
means for measuring the uplink CLI signal to determine a received power of the uplink CLI signal.

Clause 20. The apparatus of clause 19, further comprising means for determining a best receive beam, of a plurality of receive beams of the apparatus, for receiving the uplink CLI signal.

Clause 21. The apparatus of clause 20, wherein:
the means for receiving the uplink CLI signal comprise means for receiving the uplink CLI signal with each of the plurality of receive beams;
the means for measuring the uplink CLI signal comprise means for measuring the uplink CLI signal received by each of the plurality of receive beams to determine a plurality of measurements; and
the apparatus further comprises:
   means for determining, based on the plurality of measurements, the best receive beam from the plurality of receive beams; and
   means for receiving a radio frequency sensing signal using the best receive beam from the plurality of receive beams.

Clause 22. The apparatus of clause 21, wherein the means for determining the best receive beam comprise means for determining which of the plurality of receive beams corresponds to a highest received power of the plurality of measurements.

Clause 23. The apparatus of clause 21, wherein the means for determining the best receive beam comprise means for determining which of the plurality of receive beams corresponds to a highest Doppler value of the plurality of measurements.

Clause 24. The apparatus of clause 21, wherein the means for determining the best receive beam comprise:
means for determining a set of one or more of the plurality of receive beams that each correspond to a non-zero Doppler value of the plurality of measurements; and
means for determining which of the set of one or more of the plurality of receive beams corresponds to a highest received power of the plurality of measurements.

Clause 25. The apparatus of clause 19, wherein:
the means for receiving the uplink CLI signal comprise means for receiving a plurality of occasions of the uplink CLI signal via a single receive beam of the apparatus;
the means for measuring the uplink CLI signal comprise means for measuring the plurality of occasions of the uplink CLI signal to determine a plurality of measurements; and
the apparatus further comprises means for transmitting, to a network entity, a measurement report indicating which of the plurality of occasions of the uplink CLI signal corresponds to a highest received power of the plurality of measurements.

Clause 26. The apparatus of clause 19, wherein:
the means for receiving the uplink CLI signal comprise means for receiving a plurality of occasions of the uplink CLI signal via a single receive beam of the apparatus;
the means for measuring the uplink CLI signal comprise means for measuring the plurality of occasions of the uplink CLI signal to determine a plurality of measurements; and
the apparatus further comprises means for transmitting, to a network entity, a measurement report indicating which of the plurality of occasions of the uplink CLI signal corresponds to a highest Doppler value of the plurality of measurements.

Clause 27. The apparatus of clause 19, wherein:
the means for receiving the uplink CLI signal comprise means for receiving a plurality of occasions of the uplink CLI signal via a single receive beam of the apparatus;
the means for measuring the uplink CLI signal comprise means for measuring the plurality of occasions of the uplink CLI signal to determine a plurality of measurements; and
the apparatus further comprises:
   means for determining a set of one or more of the plurality of occasions that each corresponds to a non-zero Doppler value of the plurality of measurements; and
   means for transmitting, to a network entity, a measurement report indicating which of the set of one or more of the plurality of occasions corresponds to a highest received power of the plurality of measurements.

Clause 28. A non-transitory, processor-readable storage medium comprising processor-readable instructions configured to cause a processor of an apparatus to:
receive a CLI (cross-link interference) configuration indicative of an uplink CLI signal corresponding to a transmitting user equipment;
receive the uplink CLI signal;
measure the uplink CLI signal to determine a Doppler measurement; and
measure the uplink CLI signal to determine a received power of the uplink CLI signal.

Clause 29. The non-transitory, processor-readable storage medium of clause 28, further comprising processor-readable instructions configured to cause the processor to determine a best receive beam, of a plurality of receive beams of the apparatus, for receiving the uplink CLI signal.

Clause 30. The non-transitory, processor-readable storage medium of clause 29, wherein:
the processor-readable instructions configured to cause the processor to receive the uplink CLI signal comprise processor-readable instructions configured to cause the processor to receive the uplink CLI signal with each of the plurality of receive beams;
the processor-readable instructions configured to cause the processor to measure the uplink CLI signal comprise processor-readable instructions configured to cause the processor to measure the uplink CLI signal received by each of the plurality of receive beams to determine a plurality of measurements; and
the non-transitory, processor-readable storage medium further comprises processor-readable instructions configured to cause the processor to:
   determine, based on the plurality of measurements, the best receive beam from the plurality of receive beams; and
   receive a radio frequency sensing signal using the best receive beam from the plurality of receive beams.

Clause 31. The non-transitory, processor-readable storage medium of clause 30, wherein the processor-readable instructions configured to cause the processor to determine the best receive beam comprise processor-readable instructions configured to cause the processor to determine which of the plurality of receive beams corresponds to a highest received power of the plurality of measurements.

Clause 32. The non-transitory, processor-readable storage medium of clause 30, wherein the processor-readable instructions configured to cause the processor to determining the best receive beam comprise processor-readable instructions configured to cause the processor to determine which of the plurality of receive beams corresponds to a highest Doppler value of the plurality of measurements.

Clause 33. The non-transitory, processor-readable storage medium of clause 30, wherein the processor-readable instructions configured to cause the processor to determining the best receive beam comprise processor-readable instructions configured to cause the processor to:
determine a set of one or more of the plurality of receive beams that each correspond to a non-zero Doppler value of the plurality of measurements; and
determine which of the set of one or more of the plurality of receive beams corresponds to a highest received power of the plurality of measurements.

Clause 34. The non-transitory, processor-readable storage medium of clause 28, wherein:
the processor-readable instructions configured to cause the processor to receive the uplink CLI signal comprise processor-readable instructions configured to cause the processor to receive a plurality of occasions of the uplink CLI signal via a single receive beam of the apparatus;
the processor-readable instructions configured to cause the processor to measure the uplink CLI signal comprise processor-readable instructions configured to cause the processor to measure the plurality of occasions of the uplink CLI signal to determine a plurality of measurements; and
the non-transitory, processor-readable storage medium further comprises processor-readable instructions configured to cause the processor to transmit, to a network entity, a measurement report indicating which of the plurality of occasions of the uplink CLI signal corresponds to a highest received power of the plurality of measurements.

Clause 35. The non-transitory, processor-readable storage medium of clause 28, wherein:
the processor-readable instructions configured to cause the processor to receive the uplink CLI signal comprise processor-readable instructions configured to cause the processor to receive a plurality of occasions of the uplink CLI signal via a single receive beam of the apparatus;
the processor-readable instructions configured to cause the processor to measure the uplink CLI signal comprise processor-readable instructions configured to cause the processor to measure the plurality of occasions of the uplink CLI signal to determine a plurality of measurements; and
the non-transitory, processor-readable storage medium further comprises processor-readable instructions configured to cause the processor to transmit, to a network entity, a measurement report indicating which of the plurality of occasions of the uplink CLI signal corresponds to a highest Doppler value of the plurality of measurements.

Clause 36. The non-transitory, processor-readable storage medium of clause 28, wherein:
the processor-readable instructions configured to cause the processor to receive the uplink CLI signal comprise processor-readable instructions configured to cause the processor to receive a plurality of occasions of the uplink CLI signal via a single receive beam of the apparatus;
the processor-readable instructions configured to cause the processor to measure the uplink CLI signal comprise processor-readable instructions configured to cause the processor to measure the plurality of occasions of the uplink CLI signal to determine a plurality of measurements; and
the non-transitory, processor-readable storage medium further comprises processor-readable instructions configured to cause the processor to:
   determine a set of one or more of the plurality of occasions that each corresponds to a non-zero Doppler value of the plurality of measurements; and
   transmit, to a network entity, a measurement report indicating which of the set of one or more of the plurality of occasions corresponds to a highest received power of the plurality of measurements.

Clause 37. An apparatus comprising:
a transceiver;
a memory; and
a processor, communicatively coupled to the transceiver and the memory, configured to:
   obtain a transmit beam schedule indicating a sequence of a plurality of transmit beams of a transmitting user equipment for transmitting an uplink CLI signal (uplink cross-link interference signal);
   obtain one or more measurements of the uplink CLI signal made by a receiving device, each of the one or more measurements corresponding to a respective one of the plurality of transmit beams;
   determine, based on the one or more measurements, a best transmit beam of the plurality of transmit beams for transmitting the uplink CLI signal; and
   cause the transmitting user equipment to transmit a radio frequency sensing signal using the best transmit beam.

Clause 38. The apparatus of clause 37, wherein the one or more measurements comprise a plurality of measurements and wherein to determine best transmit beam the processor is further configured to determine which of the plurality of transmit beams corresponds to a highest received power of the plurality of measurements.

Clause 39. The apparatus of clause 37, wherein the one or more measurements comprise a plurality of measurements and wherein to determine the best transmit beam the processor is further configured to determine which of the plurality of transmit beams corresponds to a highest Doppler value of the plurality of measurements.

Clause 40. The apparatus of clause 37, wherein the one or more measurements comprise a plurality of measurements and wherein to determine the best transmit beam the processor is further configured to:
determine a set of one or more of the plurality of transmit beams that each correspond to a non-zero Doppler value of the plurality of measurements; and
determine which of the set of one or more of the plurality of transmit beams corresponds to a highest received power of the plurality of measurements.

Clause 41. The apparatus of clause 37, wherein the processor is further configured to:
determine the transmit beam schedule;
transmit, via the transceiver, the transmit beam schedule to the transmitting user equipment;
transmit, via the transceiver to a receiving user equipment, a receive schedule indicating a plurality of signal occasions for measuring the uplink CLI signal; and
transmit, via the transceiver to the receiving device, a request to report a best measurement corresponding to the plurality of signal occasions.

Clause 42. A method for beam management comprising:
obtaining, at an apparatus, a transmit beam schedule indicating a sequence of a plurality of transmit beams of a transmitting user equipment for transmitting an uplink CLI signal (uplink cross-link interference signal);
obtaining, at the apparatus, one or more measurements of the uplink CLI signal made by a receiving device, each of the one or more measurements corresponding to a respective one of the plurality of transmit beams; and
determining, at the apparatus and based on the one or more measurements, a best transmit beam of the plurality of transmit beams for transmitting the uplink CLI signal.

Clause 43. The method for beam management of clause 42, wherein the one or more measurements comprise a plurality of measurements and wherein determining the best transmit beam comprises determining which of the plurality of transmit beams corresponds to a highest received power of the plurality of measurements.

Clause 44. The method for beam management of clause 42, wherein the one or more measurements comprise a plurality of measurements and wherein determining the best transmit beam comprises determining which of the plurality of transmit beams corresponds to a highest Doppler value of the plurality of measurements.

Clause 45. The method for beam management of clause 42, wherein the one or more measurements comprise a plurality of measurements and wherein determining the best transmit beam comprises:
determining a set of one or more of the plurality of transmit beams that each correspond to a non-zero Doppler value of the plurality of measurements; and
determining which of the set of one or more of the plurality of transmit beams corresponds to a highest received power of the plurality of measurements.

Clause 46. The method for beam management of clause 42, further comprising:
determining the transmit beam schedule;
transmitting the transmit beam schedule to the transmitting user equipment;
transmitting, to a receiving user equipment, a receive schedule indicating a plurality of signal occasions for measuring the uplink CLI signal; and
transmitting, to the receiving device, a request to report a best measurement corresponding to the plurality of signal occasions.

Clause 47. An apparatus comprising:
means for obtaining a transmit beam schedule indicating a sequence of a plurality of transmit beams of a transmitting user equipment for transmitting an uplink CLI signal (cross-link interference signal);
means for obtaining one or more measurements of the uplink CLI signal made by a receiving device, each of the one or more measurements corresponding to a respective one of the plurality of transmit beams; and
means for determining, based on the one or more measurements, a best transmit beam of the plurality of transmit beams for transmitting the uplink CLI signal.

Clause 48. The apparatus of clause 47, wherein the one or more measurements comprise a plurality of measurements and wherein the means for determining the best transmit beam comprise means for determining which of the plurality of transmit beams corresponds to a highest received power of the plurality of measurements.

Clause 49. The apparatus of clause 47, wherein the one or more measurements comprise a plurality of measurements and wherein the means for determining the best transmit beam comprise means for determining which of the plurality of transmit beams corresponds to a highest Doppler value of the plurality of measurements.

Clause 50. The apparatus of clause 47, wherein the one or more measurements comprise a plurality of measurements and wherein the means for determining the best transmit beam comprise:
means for determining a set of one or more of the plurality of transmit beams that each correspond to a non-zero Doppler value of the plurality of measurements; and
means for determining which of the set of one or more of the plurality of transmit beams corresponds to a highest received power of the plurality of measurements.

Clause 51. The apparatus of clause 47, further comprising:
means for determining the transmit beam schedule;
means for transmitting the transmit beam schedule to the transmitting user equipment;
means for transmitting, to a receiving user equipment, a receive schedule indicating a plurality of signal occasions for measuring the uplink CLI signal; and
means for transmitting, to the receiving device, a request to report a best measurement corresponding to the plurality of signal occasions.

Clause 52. A non-transitory, processor-readable storage medium comprising processor-readable instructions configured to cause a processor of an apparatus to:
obtain a transmit beam schedule indicating a sequence of a plurality of transmit beams of a transmitting user equipment for transmitting an uplink CLI signal (cross-link interference signal);
obtain one or more measurements of the uplink CLI signal made by a receiving device, each of the one or more measurements corresponding to a respective one of the plurality of transmit beams; and
determine, based on the one or more measurements, a best transmit beam of the plurality of transmit beams for transmitting the uplink CLI signal.

Clause 53. The non-transitory, processor-readable storage medium of clause 52, wherein the one or more measurements comprise a plurality of measurements and wherein the processor-readable instructions configured to cause the processor to determine the best transmit beam comprise processor-readable instructions configured to cause the processor to determine which of the plurality of transmit beams corresponds to a highest received power of the plurality of measurements.

Clause 54. The non-transitory, processor-readable storage medium of clause 52, wherein the one or more measurements comprise a plurality of measurements and wherein the processor-readable instructions configured to cause the processor to determine the best transmit beam comprise processor-readable instructions configured to cause the processor to determine which of the plurality of transmit beams corresponds to a highest Doppler value of the plurality of measurements.

Clause 55. The non-transitory, processor-readable storage medium of clause 52, wherein the one or more measurements comprise a plurality of measurements and wherein the processor-readable instructions configured to cause the processor to determining the best transmit beam comprise processor-readable instructions configured to cause the processor to:
determine a set of one or more of the plurality of transmit beams that each correspond to a non-zero Doppler value of the plurality of measurements; and
determine which of the set of one or more of the plurality of transmit beams corresponds to a highest received power of the plurality of measurements.

Clause 56. The non-transitory, processor-readable storage medium of clause 52, further comprising processor-readable instructions configured to cause the processor to:
determine the transmit beam schedule;
transmit the transmit beam schedule to the transmitting user equipment;
transmit, to a receiving user equipment, a receive schedule indicating a plurality of signal occasions for measuring the uplink CLI signal; and
transmit, to the receiving device, a request to report a best measurement corresponding to the plurality of signal occasions.

Clause 57. A network entity comprising:
a transceiver;
a memory; and
a processor, communicatively coupled to the transceiver and the memory. configured to:
   transmit, via the transceiver, to a transmitting user equipment, one or more transmission schedules, for transmission of a plurality of uplink CLI signal occasions (uplink cross-link interference signal occasions), configured to cause the transmitting user equipment to transmit the plurality of uplink CLI signal occasions; and
   transmit, via the transceiver, to a receiving user equipment, one or more reception schedules, for receiving the plurality of uplink CLI signal occasions, configured to cause the receiving user equipment to receive the plurality of uplink CLI signal occasions;
wherein:
   the one or more transmission schedules are configured to cause the transmitting user equipment to transmit the plurality of uplink CLI signal occasions using multiple transmit beams of the transmitting user equipment; or
   the one or more reception schedules are configured to cause the receiving user equipment to receive the plurality of uplink CLI signal occasions using multiple receive beams of the receiving user equipment; or
   a combination thereof.

Clause 58. The network entity of clause 57, wherein the one or more transmission schedules and the one or more reception schedules are configured such that the receiving user equipment will receive the plurality of uplink CLI signal occasions with the multiple receive beams for each of the multiple transmit beams.

Clause 59. The network entity of clause 57, wherein:
the one or more transmission schedules are configured to cause the transmitting user equipment to intermittently repeat transmitting the plurality of uplink CLI signal occasions using the multiple transmit beams; or
the one or more reception schedules are configured to cause the receiving user equipment to intermittently repeat receiving the plurality of uplink CLI signal occasions using the multiple receive beams; or
a combination thereof.

Clause 60. A method for sensing signal scheduling comprising:
transmitting, from a network entity to a transmitting user equipment, one or more transmission schedules, for transmission of a plurality of uplink CLI signal occasions (uplink cross-link interference signal occasions), configured to cause the transmitting user equipment to transmit the plurality of uplink CLI signal occasions; and
transmitting, from the network entity to a receiving user equipment, one or more reception schedules, for receiving the plurality of uplink CLI signal occasions, configured to cause the receiving user equipment to receive the plurality of uplink CLI signal occasions;
wherein:
   the one or more transmission schedules are configured to cause the transmitting user equipment to transmit the plurality of uplink CLI signal occasions using multiple transmit beams of the transmitting user equipment; or
   the one or more reception schedules are configured to cause the receiving user equipment to receive the plurality of uplink CLI signal occasions using multiple receive beams of the receiving user equipment; or
   a combination thereof.

Clause 61. The method for sensing signal scheduling of clause 60, wherein the one or more transmission schedules and the one or more reception schedules are configured such that the receiving user equipment will receive the plurality of uplink CLI signal occasions with the multiple receive beams for each of the multiple transmit beams.

Clause 62. The method for sensing signal scheduling of clause 60, wherein:
the one or more transmission schedules are configured to cause the transmitting user equipment to intermittently repeat transmitting the plurality of uplink CLI signal occasions using the multiple transmit beams; or
the one or more reception schedules are configured to cause the receiving user equipment to intermittently repeat receiving the plurality of uplink CLI signal occasions using the multiple receive beams; or
a combination thereof.

Clause 63. A network entity comprising:
means for transmitting, to a transmitting user equipment, one or more transmission schedules, for transmission of a plurality of uplink CLI signal occasions (uplink cross-link interference signal occasions), configured to cause the transmitting user equipment to transmit the plurality of uplink CLI signal occasions; and
means for transmitting, entity to a receiving user equipment, one or more reception schedules, for receiving the plurality of uplink CLI signal occasions, configured to cause the receiving user equipment to receive the plurality of uplink CLI signal occasions;
wherein:
   the one or more transmission schedules are configured to cause the transmitting user equipment to transmit the plurality of uplink CLI signal occasions using multiple transmit beams of the transmitting user equipment; or
   the one or more reception schedules are configured to cause the receiving user equipment to receive the plurality of uplink CLI signal occasions using multiple receive beams of the receiving user equipment; or
   a combination thereof.

Clause 64. The network entity of clause 63, wherein the one or more transmission schedules and the one or more reception schedules are configured such that the receiving user equipment will receive the plurality of uplink CLI signal occasions with the multiple receive beams for each of the multiple transmit beams.

Clause 65. The network entity of clause 63, wherein:
the one or more transmission schedules are configured to cause the transmitting user equipment to intermittently repeat transmitting the plurality of uplink CLI signal occasions using the multiple transmit beams; or
the one or more reception schedules are configured to cause the receiving user equipment to intermittently repeat receiving the plurality of uplink CLI signal occasions using the multiple receive beams; or
a combination thereof.

Clause 66. A non-transitory, processor-readable storage medium comprising processor-readable instructions configured to cause a processor of a network entity to:
transmit, to a transmitting user equipment, one or more transmission schedules, for transmission of a plurality of uplink CLI signal occasions (uplink cross-link interference signal occasions), configured to cause the transmitting user equipment to transmit the plurality of uplink CLI signal occasions; and
transmit, entity to a receiving user equipment, one or more reception schedules, for receiving the plurality of uplink CLI signal occasions, configured to cause the receiving user equipment to receive the plurality of uplink CLI signal occasions;
wherein:
   the one or more transmission schedules are configured to cause the transmitting user equipment to transmit the plurality of uplink CLI signal occasions using multiple transmit beams of the transmitting user equipment; or
   the one or more reception schedules are configured to cause the receiving user equipment to receive the plurality of uplink CLI signal occasions using multiple receive beams of the receiving user equipment; or
   a combination thereof.

Clause 67. The non-transitory, processor-readable storage medium of clause 66, wherein the one or more transmission schedules and the one or more reception schedules are configured such that the receiving user equipment will receive the plurality of uplink CLI signal occasions with the multiple receive beams for each of the multiple transmit beams.

Clause 68. The non-transitory, processor-readable storage medium of clause 66, wherein:
the one or more transmission schedules are configured to cause the transmitting user equipment to intermittently repeat transmitting the plurality of uplink CLI signal occasions using the multiple transmit beams; or
the one or more reception schedules are configured to cause the receiving user equipment to intermittently repeat receiving the plurality of uplink CLI signal occasions using the multiple receive beams; or
a combination thereof.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A. B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that communication using the wireless communication device is exclusively, or evenly primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated. “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
a receiver;
a memory; and
a processor, communicatively coupled to the receiver and the memory, configured to:
receive, via the receiver, a cross-link interference (CLI) configuration indicative of an uplink CLI signal corresponding to a transmitting user equipment;
receive, via the receiver, the uplink CLI signal;
measure the uplink CLI signal to determine a Doppler measurement; and
measure the uplink CLI signal to determine a received power of the uplink CLI signal.

2. The apparatus of claim 1, wherein the processor is further configured to determine a best receive beam, of a plurality of receive beams of the receiver, for receiving the uplink CLI signal.

3. The apparatus of claim 2, wherein the receiver is configured to receive the uplink CLI signal with each of the plurality of receive beams, and wherein the processor is further configured to:
measure the uplink CLI signal received by each of the plurality of receive beams to determine a plurality of measurements;
determine, based on the plurality of measurements, the best receive beam from the plurality of receive beams; and
receive a radio frequency sensing signal using the best receive beam from the plurality of receive beams.

4. The apparatus of claim 3, wherein to determine the best receive beam the processor is further configured to determine which of the plurality of receive beams corresponds to a highest received power of the plurality of measurements.

5. The apparatus of claim 3, wherein to determine best receive beam the processor is further configured to determine which of the plurality of receive beams corresponds to a highest Doppler value of the plurality of measurements.

6. The apparatus of claim 3, wherein to determine the best receive beam the processor is further configured to:
determine a set of one or more of the plurality of receive beams that each correspond to a non-zero Doppler value of the plurality of measurements; and
determine which of the set of one or more of the plurality of receive beams corresponds to a highest received power of the plurality of measurements.

7. The apparatus of claim 1, further comprising a transmitter, wherein the processor is further configured to:
receive a plurality of occasions of the uplink CLI signal via a single receive beam of the receiver;
measure the plurality of occasions of the uplink CLI signal to determine a plurality of measurements; and
transmit, via the transmitter to a network entity, a measurement report indicating which of the plurality of occasions of the uplink CLI signal corresponds to a highest received power of the plurality of measurements.

8. The apparatus of claim 1, further comprising a transmitter, wherein the processor is further configured to:
receive a plurality of occasions of the uplink CLI signal via a single receive beam of the receiver;
measure the plurality of occasions of the uplink CLI signal to determine a plurality of measurements; and
transmit, via the transmitter to a network entity, a measurement report indicating which of the plurality of occasions of the uplink CLI signal corresponds to a highest Doppler value of the plurality of measurements.

9. The apparatus of claim 1, further comprising a transmitter, wherein the processor is further configured to:
receive a plurality of occasions of the uplink CLI signal via a single receive beam of the receiver;
measure the plurality of occasions of the uplink CLI signal to determine a plurality of measurements;
determine a set of one or more of the plurality of occasions that each corresponds to a non-zero Doppler value of the plurality of measurements; and
transmit, via the transmitter to a network entity, a measurement report indicating which of the set of one or more of the plurality of occasions corresponds to a highest received power of the plurality of measurements.

10. A method for CLI signal measurement (cross-link interference signal measurement), the method for CLI signal measurement comprising:
receiving, at an apparatus, a CLI configuration indicative of an uplink CLI signal corresponding to a transmitting user equipment;
receiving, at the apparatus, the uplink CLI signal;
measuring, at the apparatus, the uplink CLI signal to determine a Doppler measurement; and
measuring, at the apparatus, the uplink CLI signal to determine a received power of the uplink CLI signal.

11. The method for CLI signal measurement of claim 10, further comprising determining a best receive beam, of a plurality of receive beams of the apparatus, for receiving the uplink CLI signal.

12. The method for CLI signal measurement of claim 11, wherein:
receiving the uplink CLI signal comprises receiving the uplink CLI signal with each of the plurality of receive beams;
measuring the uplink CLI signal comprises measuring the uplink CLI signal received by each of the plurality of receive beams to determine a plurality of measurements; and
the method for CLI signal measurement further comprises:
determining, based on the plurality of measurements, the best receive beam from the plurality of receive beams; and
receiving a radio frequency sensing signal using the best receive beam from the plurality of receive beams.

13. The method for CLI signal measurement of claim 12, wherein determining the best receive beam comprises determining which of the plurality of receive beams corresponds to a highest received power of the plurality of measurements.

14. The method for CLI signal measurement of claim 12, wherein determining the best receive beam comprises determining which of the plurality of receive beams corresponds to a highest Doppler value of the plurality of measurements.

15. The method for CLI signal measurement of claim 12, wherein determining the best receive beam comprises:
determining a set of one or more of the plurality of receive beams that each correspond to a non-zero Doppler value of the plurality of measurements; and
determining which of the set of one or more of the plurality of receive beams corresponds to a highest received power of the plurality of measurements.

16. The method for CLI signal measurement of claim 10, wherein:
receiving the uplink CLI signal comprises receiving a plurality of occasions of the uplink CLI signal via a single receive beam of the apparatus;
measuring the uplink CLI signal comprises measuring the plurality of occasions of the uplink CLI signal to determine a plurality of measurements; and
the method for CLI signal measurement further comprises transmitting, from the apparatus to a network entity, a measurement report indicating which of the plurality of occasions of the uplink CLI signal corresponds to a highest received power of the plurality of measurements.

17. The method for CLI signal measurement of claim 10, wherein:
receiving the uplink CLI signal comprises receiving a plurality of occasions of the uplink CLI signal via a single receive beam of the apparatus;
measuring the uplink CLI signal comprises measuring the plurality of occasions of the uplink CLI signal to determine a plurality of measurements; and
the method for CLI signal measurement further comprises transmitting, from the apparatus to a network entity, a measurement report indicating which of the plurality of occasions of the uplink CLI signal corresponds to a highest Doppler value of the plurality of measurements.

18. The method for CLI signal measurement of claim 10, wherein:
receiving the uplink CLI signal comprises receiving a plurality of occasions of the uplink CLI signal via a single receive beam of the apparatus;
measuring the uplink CLI signal comprises measuring the plurality of occasions of the uplink CLI signal to determine a plurality of measurements; and
the method for CLI signal measurement further comprises:
determining a set of one or more of the plurality of occasions that each corresponds to a non-zero Doppler value of the plurality of measurements; and
transmitting, from the apparatus to a network entity, a measurement report indicating which of the set of one or more of the plurality of occasions corresponds to a highest received power of the plurality of measurements.

19. An apparatus comprising:
means for receiving a CLI (cross-link interference) configuration indicative of an uplink CLI signal corresponding to a transmitting user equipment;
means for receiving the uplink CLI signal;
means for measuring the uplink CLI signal to determine a Doppler measurement; and
means for measuring the uplink CLI signal to determine a received power of the uplink CLI signal.

20. The apparatus of claim 19, further comprising means for determining a best receive beam, of a plurality of receive beams of the apparatus, for receiving the uplink CLI signal.

21. The apparatus of claim 20, wherein:
the means for receiving the uplink CLI signal comprise means for receiving the uplink CLI signal with each of the plurality of receive beams;
the means for measuring the uplink CLI signal comprise means for measuring the uplink CLI signal received by each of the plurality of receive beams to determine a plurality of measurements; and
the apparatus further comprises:
means for determining, based on the plurality of measurements, the best receive beam from the plurality of receive beams; and
means for receiving a radio frequency sensing signal using the best receive beam from the plurality of receive beams.

22. The apparatus of claim 21, wherein the means for determining the best receive beam comprise means for determining which of the plurality of receive beams corresponds to a highest received power of the plurality of measurements.

23. The apparatus of claim 21, wherein the means for determining the best receive beam comprise means for determining which of the plurality of receive beams corresponds to a highest Doppler value of the plurality of measurements.

24. The apparatus of claim 21, wherein the means for determining the best receive beam comprise:
means for determining a set of one or more of the plurality of receive beams that each correspond to a non-zero Doppler value of the plurality of measurements; and
means for determining which of the set of one or more of the plurality of receive beams corresponds to a highest received power of the plurality of measurements.

25. The apparatus of claim 19, wherein:
the means for receiving the uplink CLI signal comprise means for receiving a plurality of occasions of the uplink CLI signal via a single receive beam of the apparatus;
the means for measuring the uplink CLI signal comprise means for measuring the plurality of occasions of the uplink CLI signal to determine a plurality of measurements; and
the apparatus further comprises means for transmitting, to a network entity, a measurement report indicating which of the plurality of occasions of the uplink CLI signal corresponds to a highest received power of the plurality of measurements.

26. The apparatus of claim 19, wherein:
the means for receiving the uplink CLI signal comprise means for receiving a plurality of occasions of the uplink CLI signal via a single receive beam of the apparatus;
the means for measuring the uplink CLI signal comprise means for measuring the plurality of occasions of the uplink CLI signal to determine a plurality of measurements; and
the apparatus further comprises means for transmitting, to a network entity, a measurement report indicating which of the plurality of occasions of the uplink CLI signal corresponds to a highest Doppler value of the plurality of measurements.

27. The apparatus of claim 19, wherein:
the means for receiving the uplink CLI signal comprise means for receiving a plurality of occasions of the uplink CLI signal via a single receive beam of the apparatus;
the means for measuring the uplink CLI signal comprise means for measuring the plurality of occasions of the uplink CLI signal to determine a plurality of measurements; and
the apparatus further comprises:
means for determining a set of one or more of the plurality of occasions that each corresponds to a non-zero Doppler value of the plurality of measurements; and
means for transmitting, to a network entity, a measurement report indicating which of the set of one or more of the plurality of occasions corresponds to a highest received power of the plurality of measurements.

28. A non-transitory, processor-readable storage medium comprising processor-readable instructions configured to cause a processor of an apparatus to:
receive a CLI (cross-link interference) configuration indicative of an uplink CLI signal corresponding to a transmitting user equipment;
receive the uplink CLI signal;
measure the uplink CLI signal to determine a Doppler measurement; and
measure the uplink CLI signal to determine a received power of the uplink CLI signal.

29. The non-transitory, processor-readable storage medium of claim 28, further comprising processor-readable instructions configured to cause the processor to determine a best receive beam, of a plurality of receive beams of the apparatus, for receiving the uplink CLI signal.

30. The non-transitory, processor-readable storage medium of claim 29, wherein:
the processor-readable instructions configured to cause the processor to receive the uplink CLI signal comprise processor-readable instructions configured to cause the processor to receive the uplink CLI signal with each of the plurality of receive beams;
the processor-readable instructions configured to cause the processor to measure the uplink CLI signal comprise processor-readable instructions configured to cause the processor to measure the uplink CLI signal received by each of the plurality of receive beams to determine a plurality of measurements; and
the non-transitory, processor-readable storage medium further comprises processor-readable instructions configured to cause the processor to:
determine, based on the plurality of measurements, the best receive beam from the plurality of receive beams; and
receive a radio frequency sensing signal using the best receive beam from the plurality of receive beams.
